(19) United States
(12) Patent Application Publication
(10) Pub. No.: US 2008/0152104 A1
(43) Pub. Date: Jun. 26, 2008

(54) INTELLIGENT SELECTION OF NETWORK ELEMENTS FOR UPGRADES

(75) Inventors: Jesse M. Keeler, Tempe, AZ (US); Juan D. Deaton, Menan, ID (US); Ronald G. Feigen, Scottsdale, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, IL (US)

(21) Appl. No.: 11/613,255

(22) Filed: Dec. 20, 2006

(51) Int. Cl. H04M 3/22

(52) U.S. Cl. 379/112.01

(57) ABSTRACT

A system (2100, 2400) for taking network elements (112) off-line includes a memory (1806) for storing a record (1802) of a number of calls being handled by a first network element (112) over a period of time and a processor (1804) communicatively coupled to the memory (1806), where the processor (1804) is used for setting a threshold value based on the record (1802), monitoring in substantially real-time, a number of calls being handled by the first network element (112), and comparing the number of substantially real-time monitored calls being handled by the first network element (112) to the threshold value. The system also includes a switch (1816) communicatively coupled to the processor, where the switch (1816) is used to take the first network element (112) off-line if the number of substantially real-time monitored calls being handled by the first network element is below the threshold value.

### BACKGROUND OF THE INVENTION

1. Field of the Invention

This invention relates in general to planned outages of base transceiver stations in a wireless network, and more particularly to reducing the number of blocked calls and dropped calls caused by strategically selecting which of a plurality of base transceiver stations to take off-line.

2. Description of the Related Art

The vast majority of populated areas of the world are now within coverage of some form of wireless network providing wireless communication services to subscribers located within that particular geographic area. The most popular of theses services is voice communication between a wireless mobile device to a second communication point, such as a second wireless device, or any other destination on the network.

Typically, the geographic area covered by a wireless network is divided into wireless communication “cells,” each of which being serviced by a base transceiver stations (BTS), which is controlled by a central base station controller (CBSC). One CBSC may control up to several hundred BTSs. A mobile subscriber unit operating within the system may move freely from one cell to another cell. As a subscriber unit moves from one geographic area to another, the system provides a mechanism for switching control of the subscriber unit from one BTS to another. More specifically, a subscriber unit is handled by a particular BTS when the subscriber unit is within the geographic region serviced by the BTS and then handed over to a neighbor BTS as the subscriber unit moves to the neighbor BTS's cell, all without dropping an active call. To support this continuing mobile subscriber unit service, the BTSs are ordinarily configured to provide overlapping geographic coverage.

From time to time, however, it is necessary to shut down or take off-line one or more BTSs. For instance, during software or hardware upgrades, repairs, scheduled maintenance, and others, all active communication through a particular BTS must be stopped. One current method for taking a BTS off-line is to essentially flip a switch and drop all active communication through that BTS. Not only do the dropped calls aggravate all affected subscribers, but if a caller tries to re-establish a call and is not within coverage of a second and active BTS, the subscriber's call will be blocked, further aggravating the subscriber.

Another method for taking BTSs off-line is to slowly reduce output signal power of the BTS. This creates a low-signal condition for the subscriber devices, causing them to search for an alternative BTS from which to get service. However, once again, not only does the poor signal from the BTS aggravate the subscriber, but if the subscriber is not within coverage of a second and active BTS to which he can switch to, the subscriber's call will be dropped and then blocked, again aggravating the subscriber.

Of course, if multiple BTSs are taken off-line, as is often the case, especially if they are all neighbors to each other, the chance of a subscriber being able to obtain service from alternative BTSs is significantly diminished. This not only creates aggravation, but may also create a dangerous situation if, for instance, a subscriber needs to reach emergency services. Examples of circumstances where multiple BTSs are taken off-line are during maintenance and repair or hardware and software upgrades of all BTS in an area or during maintenance and repair or hardware and software upgrades of a CBSC serving multiple BTSs. Since a system is often comprised of multiple instances of the same equipment, this scenario is very likely.

Therefore a need exists to overcome the problems with the prior art as discussed above.

### SUMMARY OF THE INVENTION

Briefly, in accordance with the present invention, disclosed is a method and system for taking network elements off-line, where the method includes setting at least one threshold traffic value for each of at least two network elements, monitoring, with an information processing system, in substantially real-time, a number of calls being handled by each of the at least two network elements, and determining a number of one-leg calls currently being handled by each of the at least two network elements. The method further includes comparing the number of substantially real-time monitored calls being handled by one of the at least two network elements currently handling the fewest one-leg calls to a corresponding one of the threshold values and then taking the one of the at least two network elements currently handling the fewest one-leg calls off-line if the number of substantially real-time monitored calls being handled by the one of the at least two network elements currently handling the fewest one-leg calls is below the corresponding one of the threshold values.

In accordance with an added feature, the present invention also includes changing the threshold traffic values based on a time of day of the monitoring.

In accordance with yet another feature, the present invention also includes comparing the number of substantially real-time monitored calls being handled by one of the at least two network elements currently handling the next fewest one-leg calls to a corresponding one of the threshold values and then taking the one of the at least two network elements currently handling the next fewest one-leg calls off-line if the number of substantially real-time monitored calls being handled by the one of the at least two network elements currently handling the next fewest one-leg calls is below the corresponding one of the threshold values.

In accordance with still a further feature, the present invention also includes comparing the number of one-leg calls currently being handled by the one of the at least two network elements to a one-leg call threshold value and then causing the one of the at least two network elements to stay on-line if the number of one-leg calls currently being handled by that network element exceeds the one-leg call threshold value.

In accordance with yet an added feature, the invention includes comparing an expired time to a timeout duration value and then taking the one of the at least two network elements currently handling the fewest one-leg calls off-line if the expired time exceeds the timeout duration value.

In accordance with another feature, embodiment of the invention include moving calls being handled each of the network elements prior to taking each of the network elements off-line.

In accordance with yet another added feature of the invention, the method includes storing a record of a number of calls being handled by a first network element over a period of time, setting a threshold value based on the record, and monitoring, with an information processing system, in substantially real-time, a number of calls being handled by the first network element. The number of substantially real-time monitored calls being handled by the first network element is then compared to the threshold value and the first network element is taken off-line if the number of substantially real-time monitored calls being handled by the first network element is below the threshold value.

Other features of the invention provide, prior to the step of taking the first network element off line, storing a record of a number of calls being handled by a second network element and setting a threshold value based on the record for the second network element. In substantially real-time, a number of calls being handled by the second network element is monitored and a number of one-leg calls currently being handled by each of the first network element and the second network element are determined. Then the second network element is taken off-line prior to taking the first network element off-line if the number of substantially real-time monitored calls being handled by the second network element is below the threshold value and the number of one-leg calls currently being handled by the second network element is less than the number of one-leg calls currently being handled by the first network element.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustration of a wireless communication network in accordance with one embodiment of the present invention;

FIG. 2 is an illustration of a cellular mapping pattern consisting of a group of cells in accordance with one embodiment of the present invention;

FIG. 3 is an illustration of a cellular radiation pattern in accordance with one embodiment of the present invention;

FIG. 4 is a map of cells serviced by base transceiver stations in accordance with one embodiment of the present invention.

FIG. 5 is a flow diagram illustrating the process of intelligent grouping in accordance with one embodiment of the present invention.

FIG. 6 is an illustration of a cellular mapping pattern with multiple off-line BTSs in accordance with one embodiment of the present invention.

FIG. 7 is an illustration of a cellular mapping pattern with multiple boosted BTSs in accordance with one embodiment of the present invention.

FIG. 8 is a flow diagram illustrating the process of intelligent grouping of BTSs in conjunction with power boosting in accordance with one embodiment of the present invention.

FIG. 9 is a simplified schematic view of a wireless communication unit in accordance with one embodiment of the present invention.

FIG. 10 is a flow diagram illustrating the process of forcing hand-offs from BTS to BTS in accordance with one embodiment of the present invention.

FIG. 11 is a flow diagram illustrating the process of increasing neighbor BTS power and forcing hand-offs from BTS to BTS in accordance with one embodiment of the present invention.

FIG. 11 s a flow diagram illustrating the process of intelligent grouping along with increasing neighbor BTS power and forcing hand-offs from BTS to BTS in accordance with one embodiment of the present invention.

FIG. 13 is an illustration of adjacent cells each served by a group of BTSs controlled by a CBSC in accordance with one embodiment of the present invention.

FIG. 14 is a flow diagram illustrating the process of intelligent grouping of CBSCs in accordance with one embodiment of the present invention.

FIG. 15 is a flow diagram illustrating the process of intelligent grouping of CBSCs in conjunction with power boosting of BTSs in accordance with one embodiment of the present invention.

FIG. 16 is an illustration of a radiation pattern of adjacent cells each served by a group of BTSs controlled by a CBSC in accordance with one embodiment of the present invention.

FIG. 17 is a flow diagram illustrating the process of intelligent grouping of CBSCs in conjunction with power boosting of BTSs in accordance with one embodiment of the present invention.

FIG. 18 is a block diagram illustrating an exemplary base station controller according to one embodiment of the present invention.

FIG. 19 shows an aerial view of a typical wireless coverage area including multiple BTSs according to one embodiment of the present invention.

FIG. 20 is a series of graphs showing measured call traffic loads handled at the BTS of FIG. 19 according to one embodiment of the present invention.

FIG. 21 is a system diagram of strategic scheduling using historical information according to one embodiment of the present invention.

FIG. 22 is a process flow diagram illustrating strategic scheduling using historical information as well as real-time monitoring according to one embodiment of the present invention.

FIG. 23 shows an example of a candidate schedule based on the measurements shown in FIG. 20 according to one embodiment of the present invention.

FIG. 24 is a system diagram of strategic scheduling using real-time call traffic information according to one embodiment of the present invention.

FIG. 25 is a process flow diagram illustrating strategic scheduling using historical information according to one embodiment of the present invention.

FIGS. 26-27 illustrate a process for sequentially taking network elements off-line by following a strategic scheduling plan according to one embodiment of the present invention

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The present invention relates to systems and methods for taking network service equipment off-line while greatly reducing or eliminating the dropped and/or blocked calls that normally occur. One embodiment of the present invention strategically selects BTSs as candidates for going off-line based on a real-time or expected low-service-volume window. The BTSs are chosen so that upgrades and repairs can be performed at times that will minimize the number of negatively affected subscribers.

One embodiment of the present invention strategically selects a subset of all service-providing BTSs as candidates for going off-line. The subset is chosen so as to minimize consecutive or adjacent cells that are without service, allowing subscribers to obtain service from neighbor cells, thereby greatly reducing the number of blocked calls.

According to another embodiment of the present invention, rather than decrease power of the BTS going off-line, as is done in the prior art, output power of adjacent cells is increased so that their coverage area is expanded to occupy the down cell or cells and thereby compensate for the off-line BTSs.

According to another embodiment of the present invention, the core network overwrites a value for pilot beacon signal strength reported by the subscriber units, thereby causing a mobility manager to send an instruction to all subscriber devices to acquire service from another BTS and to drop the current BTS.

According to still another embodiment, when an instruction to shut down a BTS is received, the network automatically transmits a signal to all subscribers telling them to switch BTSs from which they are receiving service. This signal provides an early warning, giving the devices time to acquire service from new BTSs without having to end the call in which they are participating.

The present invention advantageously solves the problems with the prior art in a novel and inexpensive way. An example of a system for implementing an embodiment of the invention will now be described. The system described below is in no way meant to be limiting, but is instead provided to give several examples of how the invention can be realized.

Carrier Services

Carrier networks operate on cellular networks and/or Wide Area Networks (WAN) and are controlled by cellular carriers including, but not limited to, Cingular Wireless, Sprint PCS, Metro PCS, Verizon Wireless, and T-Mobile Wireless. Cellular carriers are independent business entities that generally require a subscription to one or more services offered by that carrier in order for a user to obtain service. The services available on each carrier network, according to the present example, include voice communication, text messaging, voice mail, caller identification, internet access, data access, and others. The services also vary in quantity, such as number of minutes or amount of data uploaded and/or downloaded.

Generally, each carrier varies from each other carrier in terms of the technology used to build and operate the networks. The variances include frequency band, protocols, interfaces, and others. Carrier networks typically employ an analog-based air interface and/or one or more digital-based air interfaces. Digital-based air interfaces utilize digital communication technologies including, but not limited to, Code Division Multiple Access (CDMA), Time Division Multiple Access (TDMA), Wideband Code Division Multiple Access (WCDMA), Code Division Multiple Access-3rd Generation (CDMA2000), frequency hopping, and the like. The communication units or devices that operate within these networks have wireless communication capabilities, such as IEEE 802.11, Bluetooth, or Hyper-Lan, and the like.

The Global System for Mobile Communications (GSM) is the most popular standard for mobile phones. GSM service is currently used by over 2 billion people across more than 210 countries and territories. The ubiquity of the GSM standard makes international roaming very common between mobile phone operators, enabling subscribers to use their phones in many parts of the world. The standard also provides network operators with the ability to deploy equipment from different vendors due to the fact that the open standard allows easy inter-operability.

Integrated Digital Enhanced Network (iDEN) is an also a widely-used mobile communications technology, developed by Motorola, Inc., which provides its users the benefits of a trunked radio and a cellular telephone. Through use of a single proprietary handset, iDEN supports voice in the form of both dispatch radio and PSTN interconnection, numeric paging, Short Message Service (SMS) for text, data, and fax transmission. iDEN places more users in a given spectral space, compared to analog cellular systems, by using time division multiple access (TDMA).

System Diagram

The following examples will be helpful in understanding the present invention. Turning now to FIG. 1, a diagram of one embodiment of a network 100, in accordance with the present invention, is shown. A wireless device, or “subscriber unit” 102 is illustrated. The subscriber unit 102 communicates with a Base Station Subsystem (BSS) 104 to link to other subscriber units 103. The BSS 104 is the section of a network that is responsible for handling traffic and communication between a mobile phone 102 and a Network Switching Subsystem (NSS) 108. The BSS 104 performs allocation of radio channels to mobile phones, transcoding of speech channels, paging, quality management of transmission and reception over the wireless link 110, and many other tasks related to the radio network.

A Base Transceiver Station (BTS) 112 establishes service areas in the vicinity of the base station to support wireless mobile communication, as is known in the art. Each BTS 112 contains transceiver equipment, including a transmitter and a receiver coupled to an antenna, for transmitting and receiving radio signals. The BTS 112 also includes equipment for encrypting and decrypting communication with a Central Base Station Controller (CBSC) 114. Typically a BTS 112 will have multiple transceivers (TRXs) that allow it to serve a plurality of frequencies and sectors of a cell.

The functions of a BTS 112 vary from carrier to carrier. There are carriers in which the BTS 112 is a plain transceiver which receives information from the subscriber units through the wireless link 110 and then converts it to an interface and sends it towards the BSC 114. There are carriers that have BTSs 112 that preprocess the information, generate target cell lists and even handle intracell handover.

The BTS 112 is controlled by the CBSC 114. The CBSC 114 is the brains behind the BTSs 112 and handles allocation of radio channels, receives measurements from the mobile phones, and controls handovers from BTS to BTS. A CBSC 114 often controls 10s or even 100s of BTSs 112. Additionally, databases for the sites, including information such as BTS identifier lists, carrier frequencies, frequency hopping lists, power reduction levels, and receiving levels for cell border calculation, are stored in the CBSC 114.

Networks are often structured to have multiple CBSCs 114 distributed into regions near their respective BTSs 112, which are then connected to a large centralized Mobile Switching Center (MSC) 118 within the NSS 108. MSCs 118 are sophisticated telephone exchanges that provide circuit-switched calling, mobility management, and GSM services to the mobile phones roaming within the area that it serves. These services include data and fax, as well as SMS, call divert and others.

The NSS 108 is the component of a wireless network system that carries out switching functions and manages the communications between mobile subscriber devices 102 and the Public Switched Telephone Network (PSTN) 120. The PSTN 120 is the concentration of the world's public circuit-switched telephone networks and is in many ways similar to the Internet, which is the concentration of the world's public IP-based packet-switched networks. The PSTN 120 is largely governed by technical standards and uses E.163/E.164 addresses (known more commonly as “telephone numbers”) for addressing.

Cells

Most wireless communication networks are “cellular,” which means that mobile phones connect to it by searching for a BTS servicing a cell in which the device resides at the time. Generally, cells are categorized into four different cell sizes—macro, micro, pico, and umbrella cells. The coverage area of each cell varies according to the environment in which it is implemented. Macro cells can be regarded as cells where the base station antenna is installed on a mast or larger building structures that are taller than an average roof-top level. Micro cells are cells whose antenna height is below average roof top level and are typically used in urban areas. Picocells are small cells whose diameter is only a few dozen meters; they are used mainly in indoor applications. Lastly, umbrella cells are used to cover shadowed regions of smaller cells and fill in gaps in coverage between those cells.

A cell's radius varies greatly depending on a variety of factors, such as antenna height, antenna type, frequency, antenna gain, landscape, weather, and other propagation conditions. Typically, cells are no larger than 20 miles.

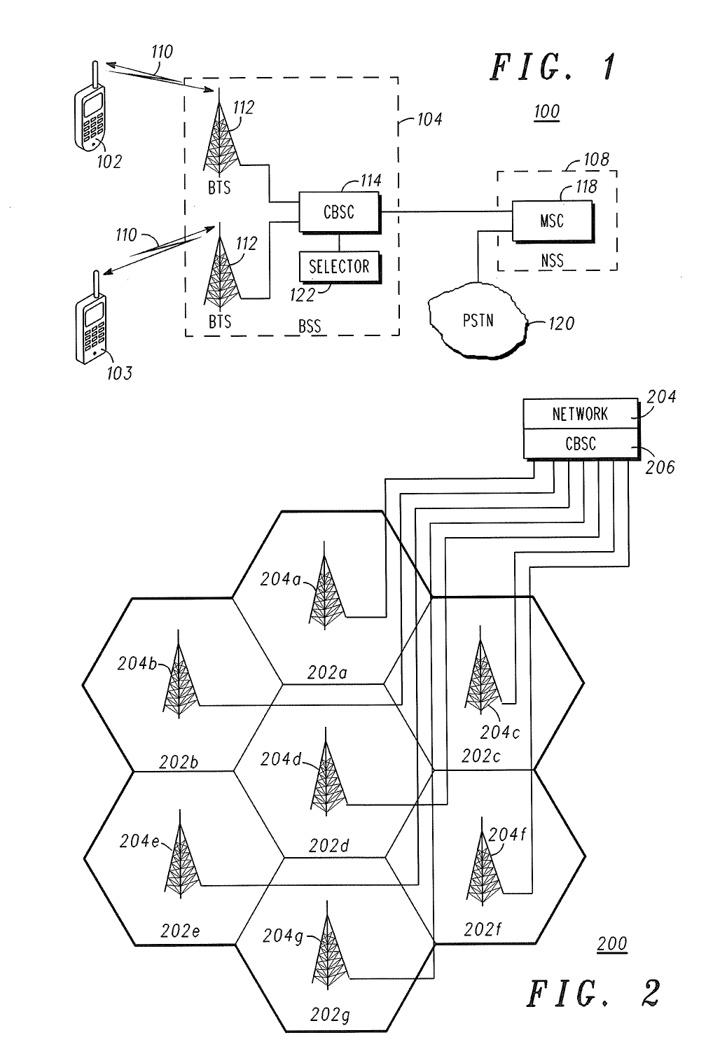

FIG. 2 illustrates an example of a cellular pattern 200, consisting of a group of cells 202a-n. The cells 202a-n are within coverage of a communication network 204. The communication network 204 includes a CBSC 206 that controls a set of BTSs 204a-n, each serving one of the cells 202a-n within the cellular pattern 200. Therefore, wireless devices that subscribe to a carrier operating network 204 are able to connect to any of BTSs 204a-n and receive wireless services provided by that carrier.

Each cell 202a-n shown in FIG. 2 is represented as having defined borders that are adjacent to multiple neighbor cells. This pattern is helpful when mapping out cells on paper to plan networks. However, when the BTSs 204a-g begin transmitting and receiving, their radiation patterns do not have edge-like borders, but are instead, a substantially round shape with edges that fade as signal strength drops as the distance from the BTS increases. Furthermore, in practice, the BTSs operate so that radiation patterns of adjacent BTSs actually overlap each other. Although the term “radiation” sometimes implies an output of airborne signals, the term is used here to refer to both signals sent and signals received.

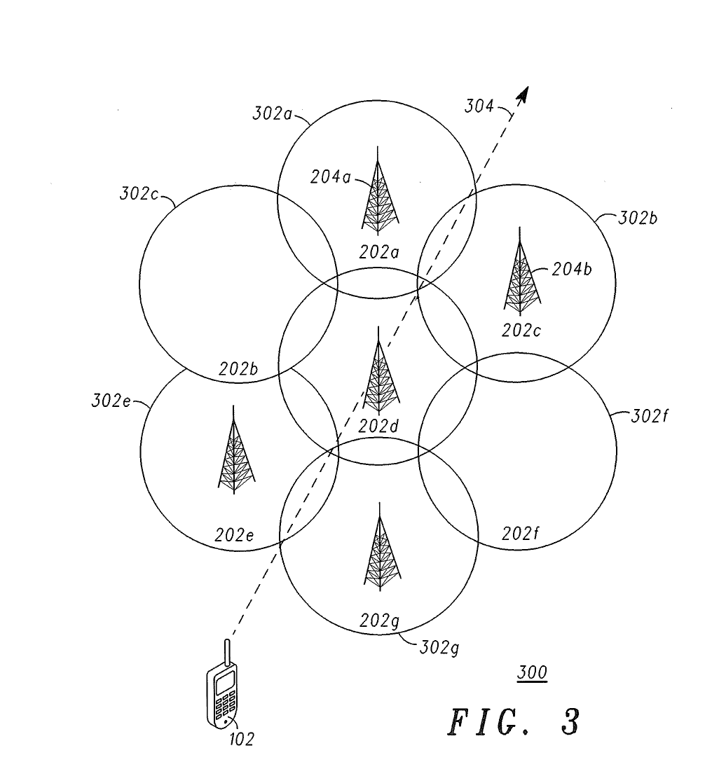

A radiation pattern 300 of the BTSs 204a-g is shown in FIG. 3. The BTS 204a of cell 202a produces radiation pattern 302a, the BTS 204b of cell 202b produces radiation pattern 302b, and so on. As can be seen, the radiation patterns 302a-g overlap, with the edges of cell 202d being completely covered by radiation patterns of the adjacent cells. A subscriber unit 102 traveling along a path 304 will spend the majority of the path being within the coverage of two or more BTSs. However, each cell has a point near the center, where a subscriber device is only within the coverage of, and only able to communicate with, a single BTS.

There are many reasons why a BTS may need to be taken off-line. The reasons include, for example, regularly scheduled maintenance, repairs, upgrades, and many others. If the BTS were to go off-line for any reason, a subscriber device 102 near the center of a cell and only within coverage of a single BTS would be dropped. The subscriber device 102 would not be able to obtain service from any other BTS because it is outside the range of the other devices. If the subscriber using the subscriber device 102 were to take the device near an edge of the down cell, the device would be able to receive communication from one of the cells bordering the downed cell. However, if a group of cells were to all go out at once, the subscriber would have to travel a great distance to be able to receive service.

Embodiments of the present invention minimize the negative impact these off-line BTS may have on subscriber devices to which the BTSs service.

Intelligent Grouping

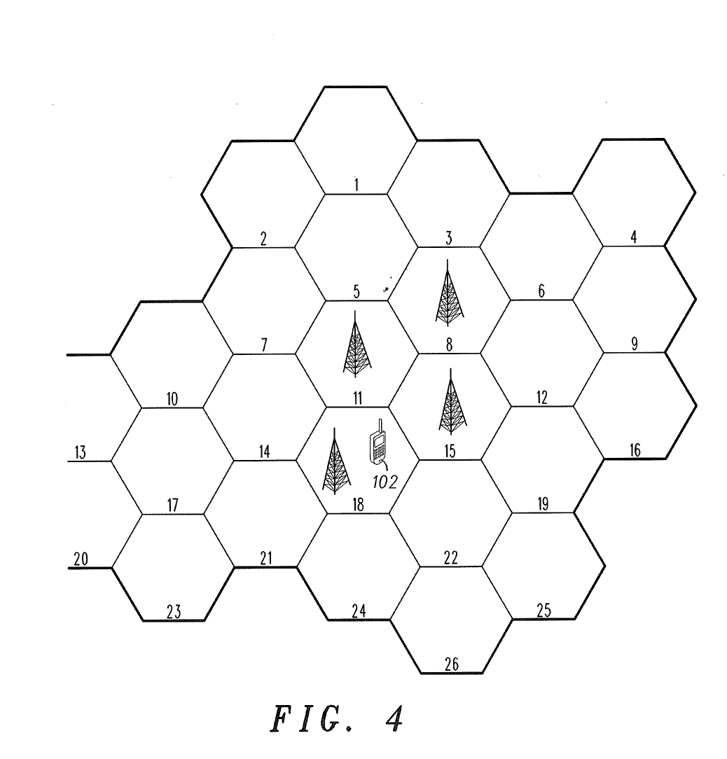

FIG. 4 in conjunction with the process flow chart of FIG. 5 shows a first embodiment of the present invention where intelligent grouping is used before BTSs are taken off-line. Intelligent grouping reduces the negative impact that planned outages will have on subscriber units by minimizing the service area that is out of service. The process begins at step 500 and moves directly to step 502 where a list is created of all the BTS that are to be considered. The BTS that are to be considered are all BTS that need to go off-line as well as near-by BTSs that may or may not go off-line. Looking at FIG. 4, all BTSs 1-26 are listed. Next, in step 504 the list is examined to make a chart indicating for each BTS, which other BTSs are geographically adjacent. For instance, in FIG. 4, BTSs 5, 7, 8, 14, 18, and 15 are all adjacent to BTS 11. Once the chart is made, in step 506, a strategic plan is developed to take BTSs off-line whereby one or more of the BTSs on the list can go off-line and ideally no two BTSs having adjacent coverage areas will be off-line at a same time.

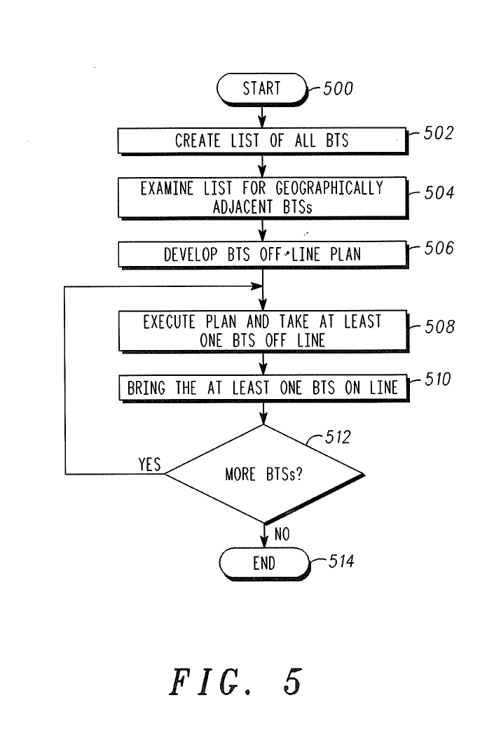

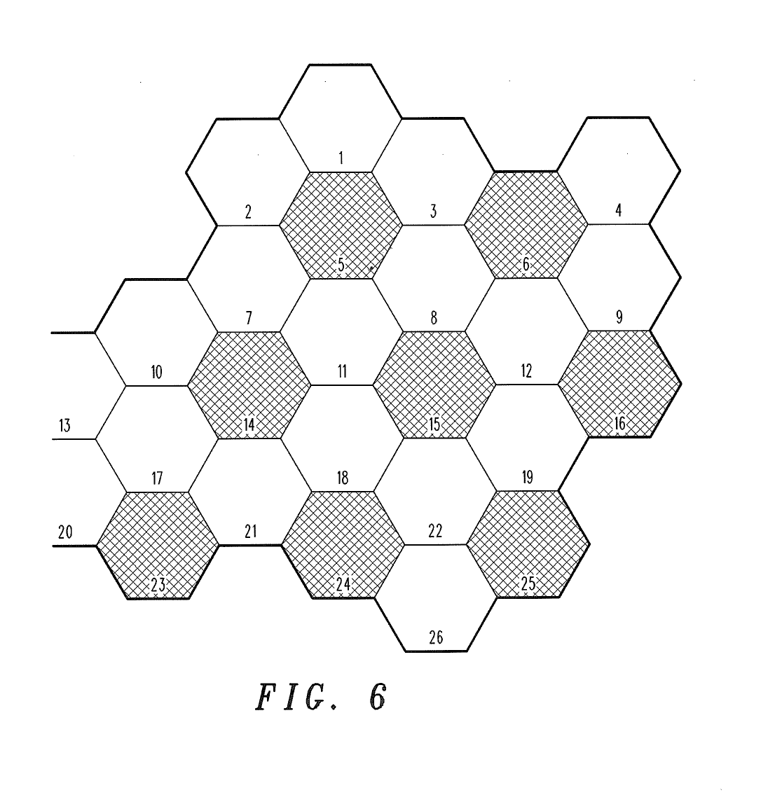

FIG. 6 shows an example of an implemented off-line plan resulting from step 506. In the example, BTSs 5, 6, 14-16, and 23-25 have been taken off-line. Subscriber units traveling within those cells will temporarily not be able to receive service from those BTSs. However, the impact on the subscriber device has been minimized because each of the off-line BTSs is surrounded by functioning BTSs. As mentioned above, there is overlap between the radiation patterns of the adjacent cells. Therefore, it is possible that a wireless device dropped from the BTS is already in range of a backup neighbor BTS and will be able to immediately place a call using the neighbor BTS. In other situations, where a particular subscriber is not in a service range of an adjacent BTS, that subscriber will not be able to immediately place another call. This is called call “blocking”. However, due to the strategic outage plan, as shown in FIG. 6, the subscriber can simply travel towards the edge of the out of service cell in order to pick up service from a neighbor BTS.

In step 508, the first stage of the plan developed in step 506 is executed and the selected BTSs are brought down. In step 510, the BTS taken off-line in step 508 are brought back online. The pattern shown in FIG. 6 can then alternate with similar strategically selected configurations until all of the BTSs have been brought down and back up again. In step 512 a decision is made to determine whether or not all of the BTSs that need to go off-line have been taken down. If the answer is yes, the flow moves to step 514 and the process ends. If the answer is no, the flow moves to back up to step 508 where a new configuration is selected and the flow continues again until all necessary BTSs have been taken off-line and brought back up again.

This method is a vast improvement over the prior art method of simply turning entire groups of BTSs off without consideration of alternative neighbor BTSs that can pick up the dropped subscribers.

Power Boosting

In another embodiment of the present invention, strategic cell selection is again utilized; however, in this embodiment, transmission power to cells adjacent to the cells going off-line is boosted to extend the range of that cell, thereby increasing the service coverage area. This method is advantageous in that more BTSs can be taken off-line at a single time.

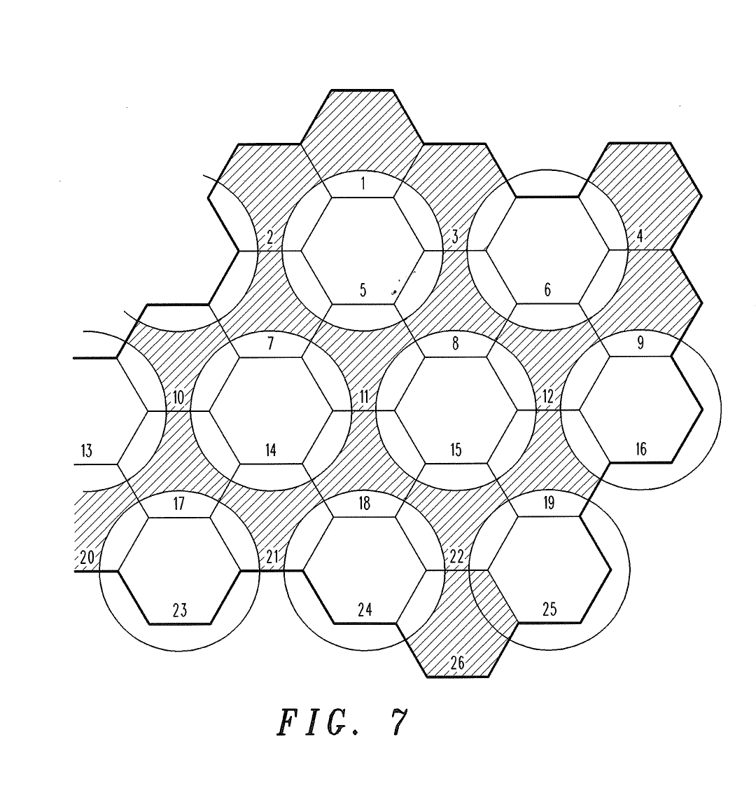

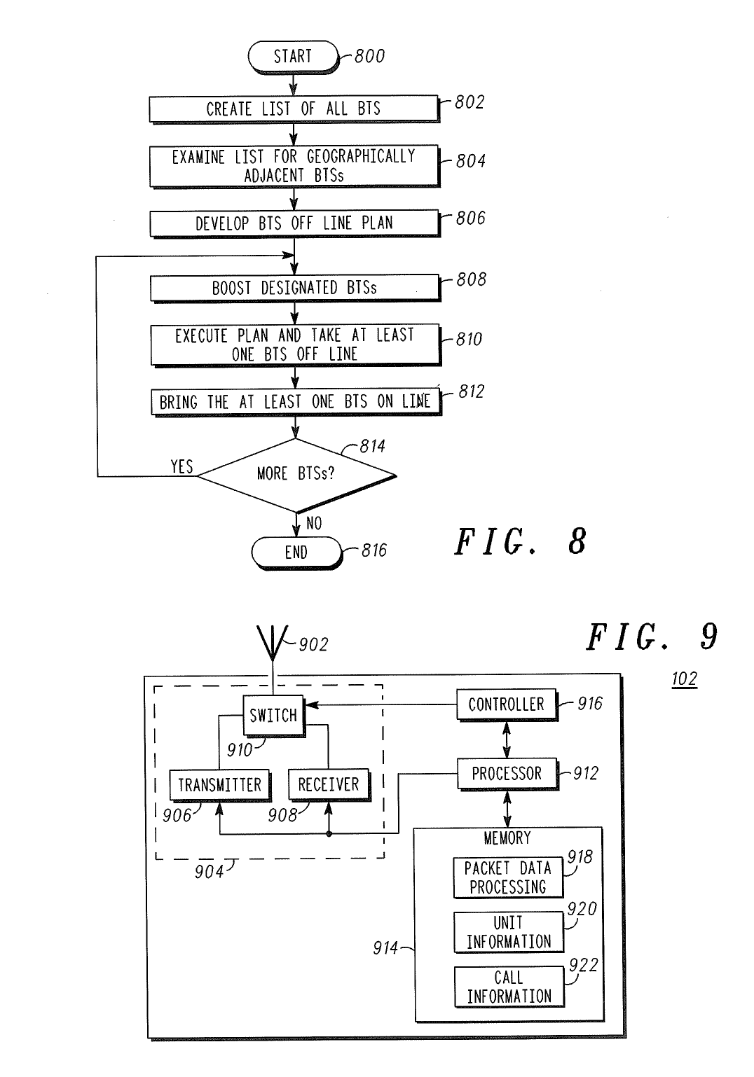

FIG. 7 in conjunction with the process flow chart of FIG. 8 shows this embodiment of the present invention where power boosting is used in conjunction with intelligent grouping to take BTSs off-line. Intelligent grouping reduces the negative impact that planned outages will have on subscriber units by minimizing the service areas that are out of service. Power boosting works to increase the service area of all boosted BTSs, thereby allowing them to provide service to areas in the off-line cell.

In this embodiment, the flow of FIG. 5 is the same, with the exception of an extra power boosting step. The process begins at step 800 and moves directly to step 802 where a list is created of all the BTSs that are to be considered. The BTSs that are to be considered are all BTSs that need to go off-line as well as near-by BTSs that may or may not go off-line. Looking at FIG. 4, all BTSs 1-26 are listed. Next, in step 804 the list is examined to determine, for each BTS, which other BTSs are geographically adjacent. For instance, in FIG. 4, BTSs 5, 7, 8, 14, 18, and 15 are all adjacent to BTS 11. Once the chart is made, in step 806, a strategic plan is developed to take BTSs off-line whereby power is boosted in one BTS and one or more adjacent cells can be taken off-line. FIG. 7 shows one example of an implemented off-line plan utilizing power boosting in conjunction with intelligent grouping.

In the example shown in FIG. 7, power to BTSs 5, 6, 13-16, and 23-25 have has been boosted. Because these BTSs are now able to provide service to a much larger service area, BTSs 1-4, 7-9, 10-12, 17-19, 20-22, and 26 can all be taken off-line at the same time. Only subscribers located in the thin areas of no coverage, represented as black in the figure, will have their calls blocked. Subscriber units traveling within those black areas will temporarily not be able to receive service. However, the impact on the subscriber device has been minimized because each of the off-line BTSs is surrounded by functioning boosted BTSs. The overlap between the radiation patterns is much greater among the adjacent cells. Therefore, with the boosted output power of the BTSs, it is possible that a wireless device dropped from the BTS is already in range of a backup neighbor BTS and will be able to immediately place a call using the neighbor BTS. In other situations, where a particular subscriber is not in a service range of an adjacent BTS, that subscriber will be blocked. However, due to the strategic outage plan in conjunction with the neighbor BTS power boosts, as shown in FIG. 7, the subscriber can simply travel towards the edge of the out of service area in order to pick up service from a neighbor BTS.

In step 808, the plan developed in step 806 is executed by first boosting designated BTSs. In the example shown in FIG. 7, power to BTSs 5, 6, 13-16, and 23-25 is increased. Next, in step 810, the selected BTSs are brought down for servicing. In step 812, the BTS taken down in step 810 are brought back online. The pattern shown in FIG. 7 can then alternate with similar strategically selected configurations until all of the BTSs have been brought down and back up again. In step 814 a decision is made to determine whether or not all of the BTSs that need to go off-line have been taken down. If the answer is yes, the flow moves to step 816 and the process ends. If the answer is no, the flow moves to back up to step 808 where a new configuration is selected and the flow continues again until all necessary BTSs have been taken off-line and brought back up again.

This method is a vast improvement over the prior art method of simply turning entire groups of BTSs off without consideration of alternate neighbor BTS service providers that can pick up the dropped subscribers. With strategic power boosting and grouping, subscribers have a much great probability of finding service during scheduled maintenance and upgrades of provider equipment than in the past.

Forced Handoff

In accordance with another embodiment of the present invention, the subscriber devices are instructed by the network to switch from a first BTS to which they are communicating through, to an alternative second BTS prior to a scheduled taking of the first BTS off-line. Briefly, in this embodiment, the core network receives a signal strength indicator from a subscriber unit. Typically, this indicator will show a signal-strength sufficient for on-going communication. However, a selector 122, shown in FIG. 1, at the front end of the core network will overwrite the signal strength indicator with a poor signal strength indicator, so as to “trick” the system into believing that the subscriber is not receiving adequate service from the first BTS. In response to reading the poor signal-strength indicator, the network sends a signal to the subscriber unit 102 to change BTSs. This embodiment is better understood after several specific details of the subscriber unit are described.

Subscriber Unit

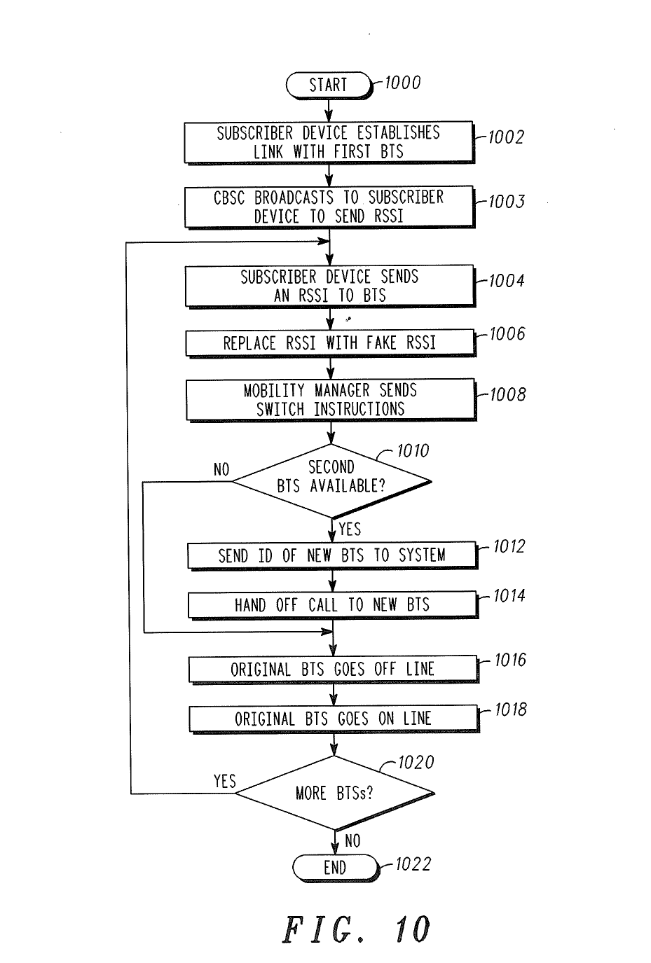

Referring now to FIG. 9, an example of a wireless device 102 is shown. Certain alternative embodiments of the present invention are not limited to cellular phones and can also be used with other wireless devices, including, but not limited to, PDA's, SmartPhones, Laptops, Pagers, Two-way Radios, satellite phones, and other communication devices. In one embodiment of the present invention, the wireless device 102 is capable of receiving and transmitting radio frequency signals over a communication channel under a communications protocol such as Code Division Multiple Access (CDMA), Frequency Division Multiple Access (FDMA), Time Division Multiple Access (TDMA), General Packet Radio Service (GPRS), and Global System for Mobile Communications (GSM) or the like. For the purposes of illustration and ease of discussion, a wireless telephone, its structures, and functions will be referred to throughout the specification.

The wireless device 102 interfaces with provider equipment via a wireless communication link established with BTSs. The wireless device 102, according to the present example, works in conjunction with the provider equipment to provide a user with services such as telephone interconnect, short message service, dispatch or instant conferencing, circuit data, packet data, and combinations thereof, as well as emergency services.

FIG. 9 shows a simplified schematic of the wireless communication unit 102, that is capable of facilitating communication with multiple BTSs in a wireless communication network. The communication unit 102 is generally known, thus the known functions and structure of such devices will not be described in detail other than as related to the inventive principles and concepts disclosed and discussed below.

The communication unit 102 includes an antenna 902 or antenna structure that operates as both an input and an output to couple radio frequency signals between a transceiver 904 and at least a first and second BTS. The transceiver 904 acts as a wireless network interface to allow the communication unit 102 to detect the presence of one or more available BTSs and communicate with one of the detected BTSs. The transceiver 904 includes a transmitter 906 and a receiver 908. The transmitter 906 and receiver 908 are coupled via an antenna switch 910 to the antenna 902. For transmit operations, the antenna switch 910 couples the transmitter 906 to the antenna 902. Similarly, for receive operations, the antenna switch 910 couples the antenna 902 to the receiver 908. For example, radio signals that are transmitted from BTSs 112 are absorbed by the antenna 902 and coupled to the receiver 908 by the switch 910.

The transceiver 904 is inter coupled and interactively operates with a processor 912. The processor 912 is a known processor-based element with functionality that will depend on the specifics of the air interfaces with the networks in communication, as well as various network protocols for voice and data traffic. The processor 912 is able to execute program instructions stored in a memory 914 and to store data received from the transceiver 904 in memory 914 and is able to operate to encode and decode voice and data messages to provide signals suitable for the transceiver 904 or further processing by a controller 916.

The memory 914 can be a combination of known RAM (Random Access Memory), ROM (Read-Only Memory), EEPROM (Electrically Erasable Programmable ROM), FLASH, or magnetic memory. The memory 914 is used to store various items or programs, an operating system, or software and data, such as caller lists, for execution or use by the processor 912. This operating software when executed by the processor 912 will result in the processor performing the requisite functions of the communication unit 102 such as interfacing with a user interface and transceiver 904. The memory 914 further includes call processing routines not specifically shown for supporting voice and data calls that will be appreciated by one of ordinary skill and that will vary depending on an air interface, call processing, and service provider or network specifics.

Additionally, the memory 914 includes packet data processes 918 that are provided for formulating appropriate packets for transport according to the specifics of the communication network. Furthermore various data is provided in the memory, specifically unit information 920, including identification information to identify the communication unit 102, and call information 922, such as strength of received signal indicators. Collectively this information can be used to identify a particular unit and identify and provide information pertaining to a particular call.

Accordingly, the transceiver 904, as controlled by, and in cooperation with, the controller 916 and functions thereof, provide the communication unit 102 with multi BTS communication capability. More particularly, the communication unit 102 is capable of acquiring a communication link with a first and second BTS in a communication network. The controller 916 can operate to determine whether the wireless device is within coverage or outside the coverage of a BTS in a particular wireless network in many different ways, as should be obvious to those of ordinary skill in the art in view of the present discussion. For example, and without limitation, some transceivers use a received signal strength indication (RSSI) signal to indicate whether the wireless device is in coverage of a wireless network. As another example, and without limitation, a signal coding scheme such as used for CDMA type wireless communication systems can be received and decoded by a transceiver to indicate whether the wireless device is in coverage. As a third example, and without limitation, a wireless device may utilize a location detection means to detect the location of the wireless device in a geographic area. A location detection means may include use of a GPS receiver or other signal receiver that indicates location of the device within a geographic area. The location of the wireless device in a geographic area may be used to determine whether the wireless device is within coverage or outside of the coverage of a wireless network. Other equivalent forms of determination of in-network or outside-of-network coverage for the wireless device should be obvious to those of ordinary skill in the art in view of the present discussion.

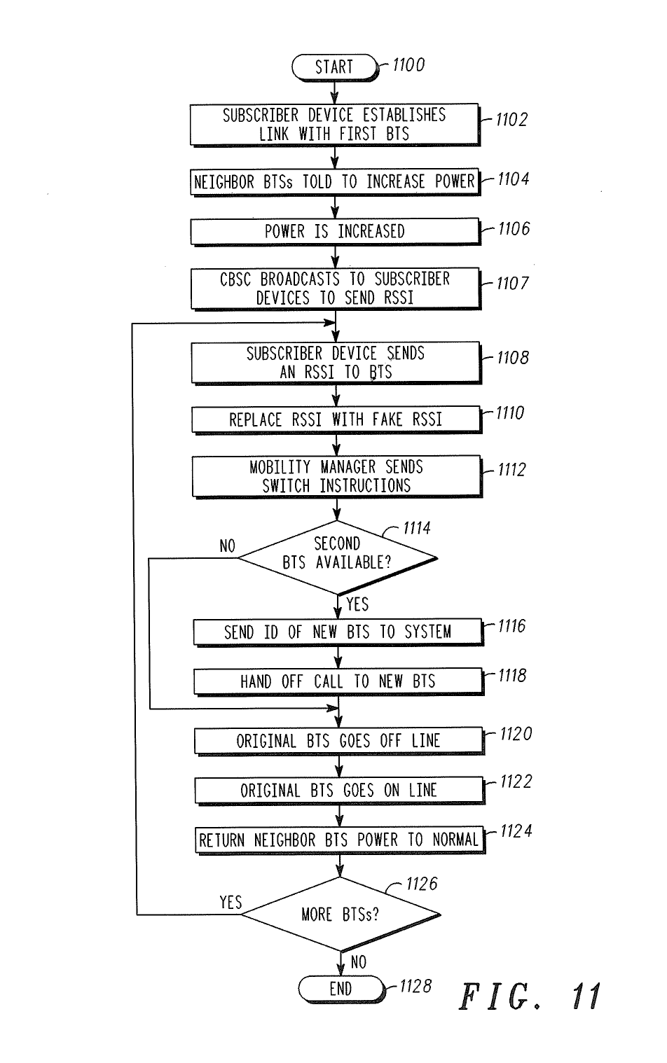

FIG. 10 is a process flow diagram of an embodiment of the present invention where subscriber units are forced to move from a first BTS to a second BTS. The process begins at step 1000 and moves directly to step 1002 where a subscriber unit establishes a communication link with a first BTS. This can be accomplished by the CBSC sending a broadcast to request all mobiles send their RSSI in step 1003. In step 1004, the subscriber unit sends an RSSI to the first BTS. Because the first BTS is scheduled to be taken off-line, the RSSI is replaced by the selector 122, in step 1006, with a “fake” RSSI that indicates a lower signal strength than the actual RSSI received. In one embodiment, the lower signal strength is zero. In other embodiments, the value is just below a minimum value to which the system will allow a subscriber device to continue to communicate with the first BTS. If the RSSI value is replaced with too low of a value, the system may tell the device to drop the call immediately, rather than allow it time to look for another BTS to transfer the call to.

In step 1008, the CBSC 114, or more specifically, a mobility manager within the CBSC 114, which handles functions such as call control, call setup, call tear down, call hand off, hand set power control, etc., interprets the lowered RSSI value and sends an instruction to the subscriber device 102 to locate a second BTS to which the call can be handed off to. The subscriber device 102 looks for service from a second BTS and if the subscriber device 102 is able to locate a second BTS, step 1010, it indicates to the system in step 1012 the identity of the second BTS. In some instances, the subscriber device 102 may already have multiple call legs set up in anticipation of a hand off. In these cases, the subscriber device 102 does not need to look for another BTS since it is already linked up. The system hands off the call, in step 1014, to the second BTS. In step 1016, the first BTS goes off-line without affecting the subscriber device 102 with which it was previously providing service to.

If, at step 1010 the subscriber device cannot locate a secondary BTS, the flow moves directly to step 1016 and the first BTS goes off-line. In this case, the subscriber device's 102 call will be dropped. After the need for the planned outage is over, the BTS will come back online in step 1018. In step 1020, a check is performed to see if additional BTS need to go off-line. If they do, the process moves back up to step 1004 where additional RSSIs are received. If no more BTS need to be serviced, the process ends at step 1018.

In one embodiment of the present invention, instead of the CBSC sending a broadcast to request all mobiles send their RSSI, as was performed in step 1002 above, one of the network elements, such as the BTS or the CBSC manufactures a “fake” RSSI value and associates the value with a subscriber device being served by one of the BTSs being considered for taking off-line. This eliminates steps 1004 and 1006 shown in FIG. 10. The flow of steps 1008-1018 will remain the same.

Forced Handoff with Neighbor Boost

One embodiment of the present invention uses forced handoff as described in the preceding section, but adds the feature of boosted neighbor BTS power prior to handoff and subsequent taking off-line of the BTS the call was handed over from. In this embodiment, the range of one or more selected neighbor BTSs is extended by boosting the output power of the neighbor BTS so as to facilitate a handoff of BTS supported service of subscriber units.

More specifically, suppose a cell, as shown in FIG. 4, is serviced by a BTS 18 that provides wireless service to the entire cell and is scheduled to go off-line for some period of time. Suppose also that an adjacent cell is serviced by a BTS 15 that provides wireless service to the entire cell. According to an embodiment of the present invention, a power level of BTS 15 is boosted prior to BTS 18 going off-line. The coverage area of the cell serviced by BTS 15 will thereby be increased and will extend into the cell serviced by BTS 18 as shown in FIG. 7.

FIG. 11 shows a process flow diagram of forced handoff coordinated with power boosting, according to a specific embodiment of the present invention. The process begins at step 1100 and moves directly to step 1102 where a communication link is established between a subscriber device 102 and a first BTS 402. In a second step 1104, the network 104 sends an instruction to a selected neighbor BTS 404 to increase output power. The second BTS 404 responds by increasing power in step 1106.

The CBSC 114 sends a broadcast to request all mobiles to send their RSSI in step 1107. In step 1108, the first BTS 402 receives an RSSI from the subscriber unit 102. Because the first BTS 402 is scheduled to be taken off-line, the RSSI is replaced, in step 1110, with a “fake” RSSI that indicates a lower signal strength than the actual RSSI received. In one embodiment the lower signal strength is zero and in other embodiments, the value is just below a minimum value to which the system will allow a subscriber to device to continue to communicate with the first BTS 402. If the RSSI value is replaced with too low of a value, the system may tell the device to drop the call immediately, rather than give it time to look for another BTS to transfer the call to without interrupting the call.

In step 1112, the CBSC 114 interprets the lowered RSSI value and sends an instruction to the subscriber device 102 to locate a second BTS to which the call can be handed off to. The subscriber device 102 looks for service from a second BTS and if the subscriber device 102 is able to locate a second BTS, step 1114, it indicates to the system in step 1116 the identity of the second BTS. The system hands off the call, in step 1118, to the second BTS. In step 1120, the first BTS goes off-line without affecting the subscriber device 102 with which it was previously providing service to.

If, at step 1114 the subscriber device cannot locate a secondary BTS, the flow moves directly to step 1120 and the first BTS goes off-line. In this case, the subscriber device's 102 call will be dropped. After the need for the planned outage is over, the BTS will come back online in step 1122 and the boosted power of the neighbor BTS will be reduced to normal in step 1124. In step 1126, a check is performed to see if additional BTS need to go off-line. If they do, the process moves back up to step 1104 where additional RSSIs are received. If no more BTS need to be serviced, the process ends at step 1128.

Forced Handoff with Intelligent Grouping and Neighbor Boost

One embodiment of the present invention utilizes intelligent grouping, as described above and shown in FIGS. 5 and 6, in coordination with forced handoff and neighbor BTS boost as described in the preceding sections and shown in FIGS. 7-11 to take multiple BTSs off-line. This embodiment further reduces dropped calls resulting from scheduled outages of BTS.

The process flow diagram of FIG. 12 shows the steps for taking one or more BTSs out of service while greatly reducing the number of dropped calls. In this embodiment, the flow of FIG. 12, the process begins at step 1200 and moves directly to step 1202 where a list is created of all the BTS that are to be considered. The BTS that are to be considered are all BTS that need to go off-line as well as near-by BTSs that may or may not go off-line. Using the cells shown in FIG. 4, all BTSs 1-26 would be placed on the list. Next, in step 1204 the list is examined to make a chart indicating for each BTS, which other BTSs are geographically adjacent. For instance, in FIG. 4, BTSs 5, 7, 8, 14, 18, and 15 are all adjacent to BTS 11. Once the chart is made, in step 1206, a strategic plan is developed to take two or more BTSs off-line whereby power is boosted in one or more adjacent neighbor BTSs to help compensate for the BTSs being taken off-line. FIG. 7 shows one example of an implemented off-line plan utilizing power boosting in conjunction with intelligent grouping.

In the example shown in FIG. 7, power to BTSs 5, 6, 13-16, and 23-25 have has been boosted. Because these BTs are now able to provide service to a much larger service area, BTSs 1-4, 7-9, 10-12, 17-19, 20-22, and 26 can all be taken off-line at the same time. Only subscribers located in the thin areas of no coverage, represented as black in the figure, will not be able to be handed off to a neighbor BTS.

In step 1208, the plan developed in step 1206 is executed by first boosting the designated BTSs. In the example shown in FIG. 7, power to BTSs 5, 6, 13-16, and 23-25 is increased. Next, in step 1210, a first BTS 402, as shown in FIG. 4, receives an RSSI from the subscriber unit 102. Because the first BTS 402 is scheduled to be taken off-line, the RSSI is replaced, in step 1212, with a “fake” RSSI that indicates a lower signal strength than the actual RSSI received. In step 1214, the CBSC 114 interprets the lowered RSSI value and sends an instruction to the subscriber device 102 to locate a second BTS to which the call can be handed off to.

The subscriber device 102 looks for service from a second BTS and if the subscriber device 102 is able to locate a second BTS, step 1216, it indicates to the system in step 1218 the identity of the second BTS. The system hands off the call, in step 1220, to the second BTS. In step 1222, the first BTS goes off-line without affecting the subscriber device 102 with which it was previously providing service to.

If, at step 1216 the subscriber device cannot locate a secondary BTS, the flow moves directly to step 1222 and the first BTS goes off-line. In this case, the subscriber device's 102 call will be dropped. After the need for the planned outage is over, the BTS will come back online in step 1224, the neighbor BTS powers are reduced back down to normal levels in step 1226, and operation returns to normal, including accurate RSSI communication.

The pattern shown in FIG. 7 can then alternate with similar strategically selected configurations until all of the BTSs have been brought down and back up again. In step 1228, a decision is made to determine whether or not all of the BTSs that need to go off-line have been taken down. If they do, the process moves back up to step 1208 where additional neighbor BTS power is boosted and the flow continues again until all necessary BTSs have been taken off-line and brought back up again. If no more BTS need to be serviced, the process ends at step 1230.

This method is a vast improvement over the prior art method of simply turning entire groups of BTSs off without consideration of handoffs to alternate neighbor BTS service providers that can pick up the dropped subscribers. With forced handoff coordinated with strategic power boosting and grouping, subscribers have a much great probability of finding service during scheduled maintenance and upgrades of provider equipment than in the past.

Strategic Planning for CBSC Shutdown

The reasons given above for planned outages of BTS apply to other device within the wireless network as well. On such device is the CBSC 114 shown in FIG. 1. CBSCs 114 require periodic scheduled maintenance and upgrades. Because a single CBSC 114 controls hundreds of BTSs 112, out of service CBSCs 114 have a much more detrimental impact on the network than do out of service BTSs. For this reason, one embodiment of the present invention utilizes strategic geographic planning of off-line CBSCs. Other embodiments of the present invention add the feature of power boosting of adjacent BTSs as well as forced handoffs.

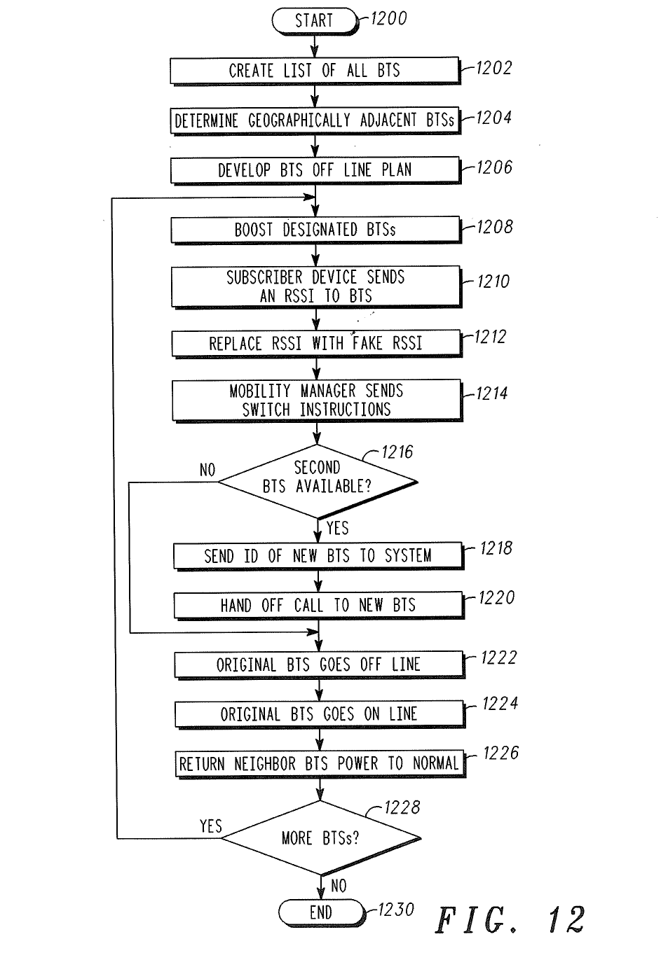

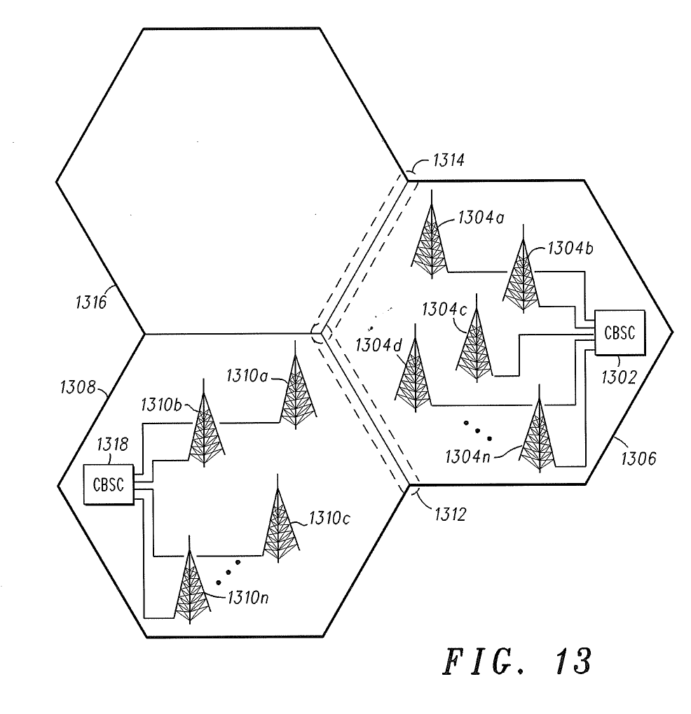

FIGS. 13, in conjunction with the process flow chart of FIG. 14 shows embodiments of the present invention where intelligent grouping is used before CBSCs are taken off-line. FIG. 13 shows a typical system architecture, where all of the BTS controlled by a single CBSC are in one general area. For instance, CBSC 1302 controls all of the BTSs 1304a-n in an area 1306. Adjacent to area 1306 is an area 1308 that includes a set of BTSs 1310a-n all controlled by a single CBSC 1318. Between the two areas 1306, 1308 is a “seam” 1312, where coverage of the first group of BTSs 1304a-n controlled by the first CBSC 1302 overlaps coverage of the second group of BTSs 1310a-n controlled by the second CBSC 1318. Similar seams, such as seam 1314, exist between other areas adjacent to each cell.

By strategically shutting down a CBSC while ensuring that neighbor CBSCs remain in service, service to subscriber devices along the seams 1312, 1314, etc., can be maintained. More specifically, with reference still to FIG. 13, if CBSC 1302 and neighbor CBSC 1318 were shut down at the same time, subscriber devices within the seam 1312 as well as within the cells 1306 and 1308 would be dropped and blocked. However, by using strategic planning, and not shutting down two neighboring CSBCs at the same time, service to subscriber devices along the seam 1312 can be maintained. This applies to other seams, such as seam 1314 between cell 1306 and adjacent cell 1316, as well.

The process flow chart of FIG. 14 helps illustrate this embodiment of the present invention. The process begins at step 1400 and moves directly to step 1402 where a list is created of all the CBSCs that are to be considered. The CBSCs that are to be considered are all CBSCs that need to go off-line as well as near-by CBSCs that may or may not go off-line. Looking at FIG. 13, CBSCs 1306 and 1308 are listed. Next, in step 1404 a list of BTSs controlled by each CBSC is made. The list includes a geographic location of each of the BTSs. In step 1406, the list is examined to determine for each CBSC, which BTS groups controlled by that and other CBSCs are geographically adjacent. For instance, in FIG. 13, BTSs 1310a-n controlled by CBSC 1306 are all adjacent to BTSs 1304a-n controlled by BTS 1302. Once the determination is made, in step 1408, a strategic plan is developed to take one or more CBSCs off-line whereby maximum coverage at the seams is maintained. This includes leaving CBSCs controlling adjacent groups of BTSs in service so that one or more groups of BTSs on the list can go off-line and no two BTSs having adjacent coverage areas will be off-line at a same time.

With reference to FIG. 13, CBSC 1302 can go off-line and subscriber devices in the seam 1312 will still receive coverage because there is an overlap between the radiation patterns of the adjacent cells. Therefore, it is possible that a wireless device dropped from the BTSs 1304a-n is already in range of at least one of the backup neighbor BTS 1310a-n and will be able to immediately place a call using the neighbor BTS 1310a-n.

In other situations, where a particular subscriber is not in a service range of one of an adjacent group of BTSs, that subscriber will be at least temporarily blocked from placing another call. However, due to the strategic outage plan, the subscriber can simply travel towards the seam of the out-of-service cell in order to pick up service from a neighbor CBSC.

In step 1410, the first stage of the plan developed in step 1408 is executed and the selected CBSCs are brought down. In step 1412, the CBSCs are brought back online. In step 1414, a decision is made to determine whether or not all of the CBSCs that need to go off-line have been taken down. If the answer is yes, the flow moves to step 1416 and the process ends. If the answer is no, the flow moves to back up to step 1410 where a new configuration is selected and the flow continues again until all necessary CBSCs have been taken off-line and brought back up again.

Strategic Planning with Power Boosting for CBSC Shutdown

In another embodiment of the present invention, strategic CBSC selection is again utilized; however, in this embodiment, transmission power to BTSs in areas adjacent to the BTSs going off-line is boosted to extend the range of those BTSs, thereby increasing the service coverage area. This method is advantageous in that more area of a region adjacent a group of BTSs can be serviced.

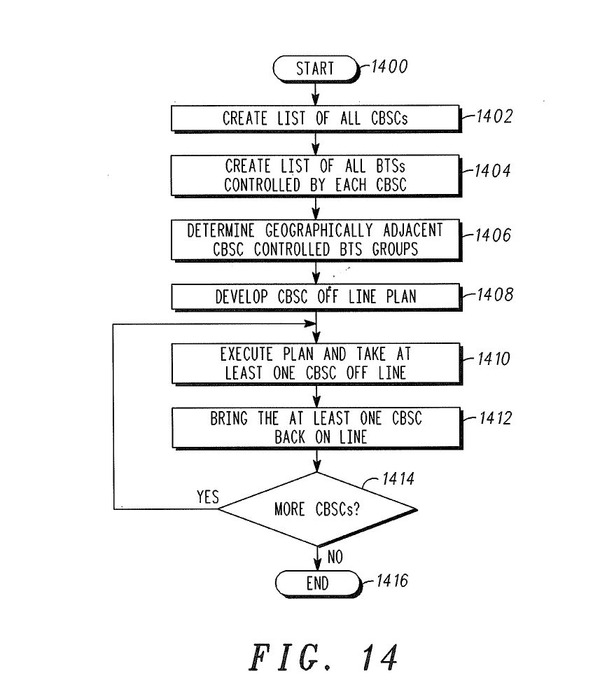

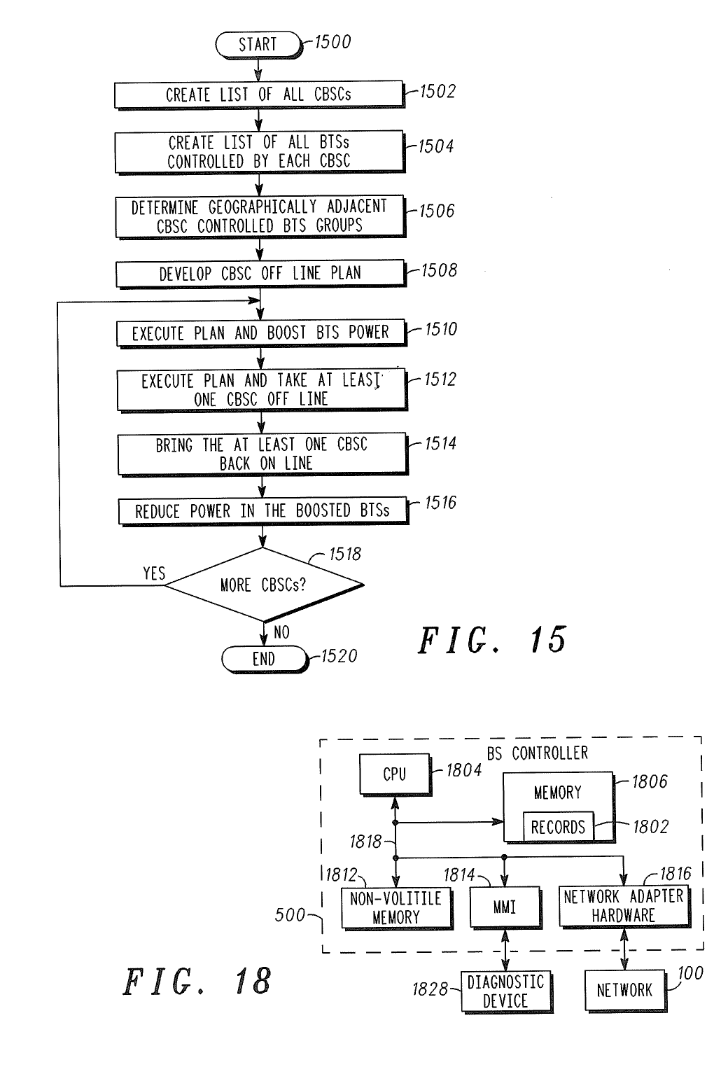

FIG. 16 in conjunction with the process flow chart of FIG. 15 shows this embodiment of the present invention where power boosting is used in conjunction with intelligent grouping to take CBSCs off-line. Intelligent grouping reduces the negative impact that planned outages will have on subscriber units by minimizing the service areas that are out of service. Power boosting works to increase the service area of all boosted BTSs, thereby allowing them to provide service to the affected areas.

This embodiment is similar to that shown in the flow of FIG. 14, with the exception of an extra power boosting step. The process begins at step 1500 and moves directly to step 1502 where a list is created of all the CBSCs that are to be considered. The CBSCs that are to be considered are all CBScs that need to go off-line as well as near-by CBSCs that may or may not go off-line.

Looking at FIG. 13, CBSCs 1318 and 1302 are listed. Next, in step 1504 a list of BTSs controlled by each CBSC is made. The list includes a geographic location of each of the BTSs. In step 1506, the list is examined to determine for each CBSC, which BTS groups controlled by that and other CBSCs are geographically adjacent. For instance, in FIG. 13, BTSs 1310a-n controlled by CBSC 1306 are all adjacent to BTSs 1304a-n controlled by BTS 1302. Once the determination is made in step 1506, a strategic plan is developed in step 1508 to take one or more CBSCs off-line whereby maximum coverage at the seams is maintained. This includes leaving CBSCs controlling adjacent groups of BTSs in service so that one or more groups of BTSs on the list can go off-line and no two BTSs having adjacent coverage areas will be off-line at a same time.

Power to BTSs near the seam are then boosted. In the example shown in FIG. 16, power to BTSs 1310a and 1310c is boosted. Because these BTSs are now able to provide service to a much larger service area, CBSC 1302 can be taken off-line with less detrimental effect on the subscriber devices previously receiving coverage from one of the BTSs 1304a-n controlled by CBSC 1302. With the boosted output power of BTSs 1310a and 1310c, it is much more likely that a wireless device dropped from one of the BTS 1302a-n is already in range of a backup neighbor and will be able to immediately place a call using one of the neighbor BTS. In other situations, where a particular subscriber is not in a service range of an adjacent BTS, that subscriber will be blocked. However, due to the strategic outage plan in conjunction with the neighbor BTS power boosts, as shown in FIG. 16, the subscriber can simply travel towards the edge of the out of service area in order to pick up service from a neighbor BTS.

In step 1510, the plan developed in step 1508 is executed by first boosting designated BTSs. In the example shown in FIG. 16, power to BTSs 1310a and 1310c, because they are closest to the seam, is increased. Next, in step 1512, the selected BTSs are brought down for servicing. In step 1514, the BTS are brought back online. In step 1516, power is reduced in the boosted BTSs.

In step 1518 a decision is made to determine whether or not all of the CBSCs that need to go off-line have been taken down. If the answer is yes, the flow moves to step 1520 and the process ends. If the answer is no, the flow moves to back up to step 1510 where a new configuration is selected and the flow continues again until all necessary CBSCs have been taken off-line and brought back up again.

Forced Handoff with Intelligent CBSC Grouping and Neighbor BTS Boost

One embodiment of the present invention utilizes intelligent grouping, as described above, in coordination with forced handoff and neighbor BTS boost, as also described in the preceding sections, to take multiple CBSCs off-line. This embodiment further reduces dropped calls resulting from scheduled outages of CBSCs.

The process flow diagram of FIG. 17 shows the steps for taking one or more CBSCs out of service while greatly reducing the number of dropped calls. In this embodiment, as shown in the flow of FIG. 17, the process begins at step 1700 and moves directly to step 1702 where a list is created of all the CBSCs that are to be considered. The CBSCs that are to be considered are all CBSCs that need to go off-line as well as near-by CBSCs that may or may not go off-line. Looking at FIG. 13, CBSCs 1318 and 1302 are listed. Next, in step 1704 a list of BTSs controlled by each CBSC is made. The list includes a geographic location of each of the BTSs. In step 1706, the list is examined to determine for each CBSC, which BTS groups controlled by that and other CBSCs are geographically adjacent. For instance, in FIG. 13, BTSs 1310a-n controlled by CBSC 1306 are all adjacent to BTSs 1304a-n controlled by BTS 1302. Once the determination is made, in step 1706, a strategic plan is developed to take one or more CBSCs off-line whereby maximum coverage at the seams is maintained. This includes leaving CBSCs controlling adjacent groups of BTSs in service so that one or more groups of BTSs on the list can go off-line and no two BTSs having adjacent coverage areas will be off-line at a same time.

In the example shown in FIG. 16, power to BTSs 1310a-n has been boosted. Because these BTSs are now able to provide service to a much larger service area, CBSC 1302 can be taken off-line with less detrimental effect on the subscriber devices previously receiving coverage from one of the BTSs 1304a-n controlled by CBSC 1302. With the boosted output power of the BTSs 1310a-n, it is much more likely that a wireless device dropped from one of the BTS 1302a-n is already in range of a backup neighbor BTS 1310a-n and will be able to immediately place a call using one of the neighbor BTS. In other situations, where a particular subscriber is not in a service range of an adjacent BTS, that subscriber will be blocked. However, due to the strategic outage plan in conjunction with the neighbor BTS power boosts, as shown in FIG. 16, the subscriber can simply travel towards the edge of the out of service area in order to pick up service from a neighbor BTS.

In step 1710, the plan developed in step 1708 is executed by first boosting the designated BTSs. In the example shown in FIG. 16, power to BTSs 1310a-n is increased. Next, in step 1712, one of the group of BTSs 1304a-n, as shown in FIG. 16, receives an RSSI from the subscriber unit 102. Because the CBSC 1302 is scheduled to be taken off-line, the RSSI is replaced, in step 1714, with a “fake” RSSI that indicates a lower signal strength than the actual RSSI received. In step 1716, the CBSC 114 interprets the lowered RSSI value and sends an instruction to the subscriber device 102 to locate a second BTS to which the call can be handed off to.

The subscriber device 102 looks for service from a second BTS and if the subscriber device 102 is able to locate a second BTS, step 1718, it indicates to the system in step 1720 the identity of the second BTS. The system hands off the call, in step 1722, to the second BTS. In step 1724, the first BTS goes off-line without affecting the subscriber device 102 with which it was previously providing service to.

If, at step 1718 the subscriber device cannot locate a secondary BTS, the flow moves directly to step 1724 and the first CBSC goes off-line. In this case, the subscriber device's 102 call will be dropped. After the need for the planned outage is over, the BTS will come back online in step 1224, the neighbor BTS powers are reduced back down to normal levels in step 1226, and operation returns to normal, including accurate RSSI communication.

The process can then alternate with similar strategically selected configurations until all of the CBSCs have been brought down and back up again. In step 1730 a decision is made to determine whether or not all of the CBSCs that need to go off-line have been taken down. If the answer is yes, the flow moves to step 1732 and the process ends. If the answer is no, the flow moves to back up to step 1710 where a new configuration is selected and the flow continues again until all necessary CBSCs have been taken off-line and brought back up again.

This method is a vast improvement over the prior art method of simply turning entire groups of BTSs off without consideration of handoffs to alternate neighbor BTS service providers that can pick up the dropped subscribers. With forced handoff coordinated with strategic power boosting and grouping, subscribers have a much great probability of finding service during scheduled maintenance and upgrades of provider equipment than in the past.

Base Station Controller

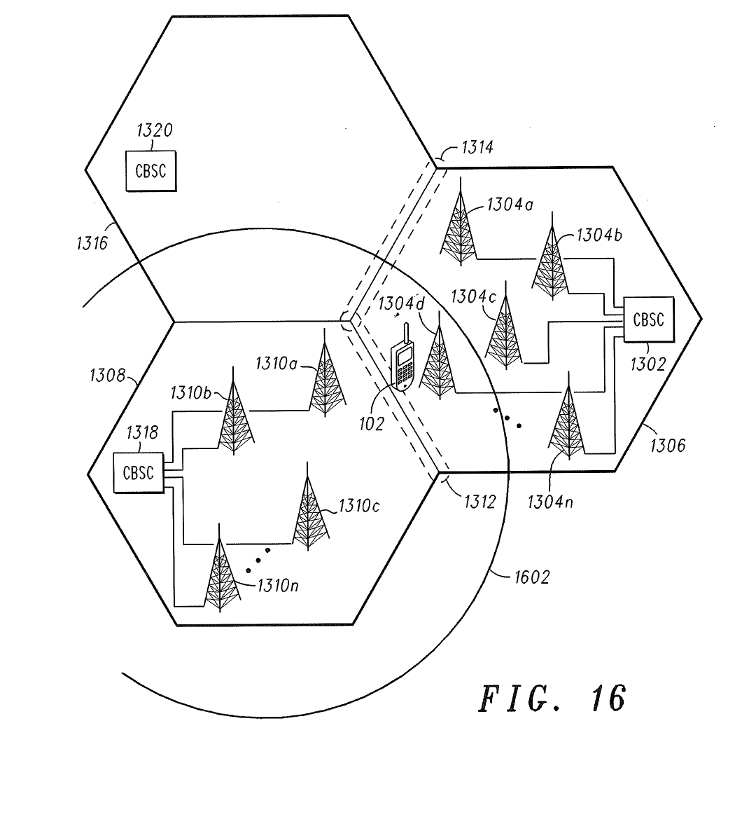

FIG. 18 is a block diagram illustrating a detailed view of a BSC 1800, such as the CBSC 114 of FIG. 1, according to an embodiment of the present invention. The BSC 1800, in one embodiment, resides within a BTS 112. In other embodiments, the BSC 1800 resides outside of and is communicatively coupled to one or more of the BTSs 112. The BSC 1800 includes a processor/controller 1804 that is communicatively connected to a main memory 1806 (e.g., volatile memory), a non-volatile memory 1812, and a network adapter hardware 1816 that is used to provide an interface (i.e., input/output) to the network 100. The processor/controller 1804 in conjunction with the network adapter hardware 1816 works as a power level controller for increasing a communication power level selected BTS so as to provide service to a larger coverage area. In addition, the processor/controller 1804 in conjunction with instructions in memory 1806 and the network adapter hardware 1816 works as a switch for taking BTSs on and off-line.

An embodiment of the present invention can be adapted to work with any data communications connections including present day analog and/or digital techniques or via a future networking mechanism. The BSC 1800 also includes a man-machine interface (“MMI”) 1814. The MMI 1814, in one embodiment, is used to directly connect one or more diagnostic devices 1828 to the BSC 1800. A system bus 1818 interconnects these system components.

Strategic Scheduling

Several methods of placing pre-selected network elements into an off-line state in a manner that reduces the number of negatively-affected subscribers have been described above. However, thus far, methods for strategically selecting the network elements to focus on have not been dealt with. The present invention, according to several additional embodiments, provides a precursor step of strategic network element selection. By carefully choosing which network elements, i.e. BTSs, CBSCs, etc, are taken down according to the previously described methods, the number of adversely affected subscribers can be even further reduced.

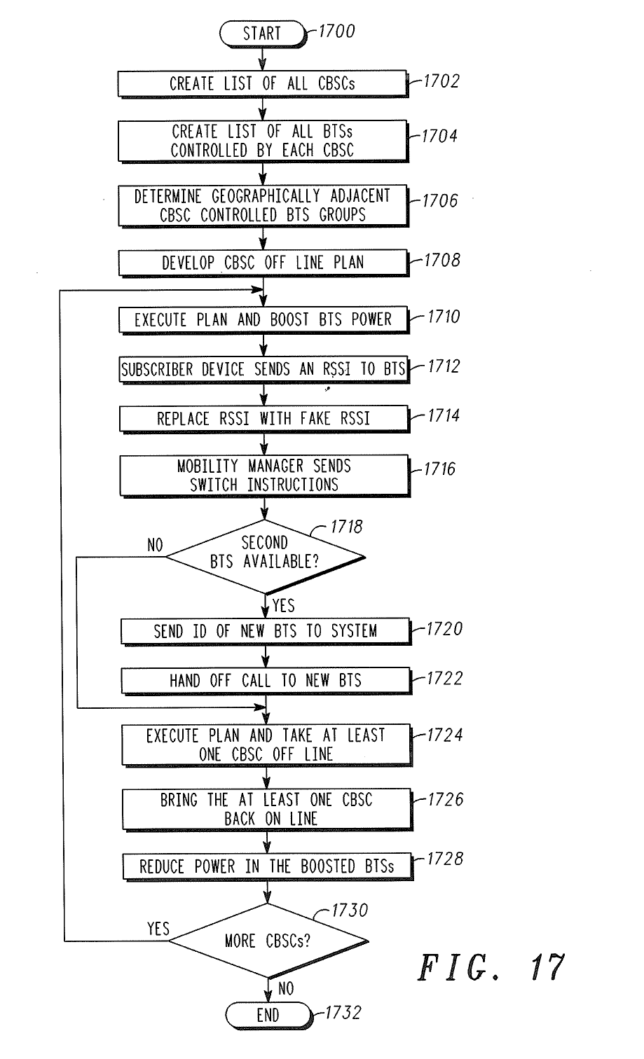

FIG. 19 shows an aerial view 1900 of a portion of a typical coverage area that is at least several cities wide. The view 1900 includes seven BTSs BTS-1-BTS-7. The geographic location of a BTS typically causes that BTS's call traffic to vary from other BTSs. For instance, BTSs located within or near a city, typically will have more traffic at night than does a BTS in an area with less night-time activities available and a lower surrounding population. However, some BTSs may be in an area outside a city, but in an area that has all-night manufacturing facilities, sports stadiums, a major highway exchange, or other factors that contribute to night-time call traffic. Therefore, it is difficult to accurately predict when the lowest network traffic time will be for a particular BTS without performing a survey of network traffic loads over time.

FIG. 20 shows a series of examples of measured call traffic handled at six of the BTS shown in FIG. 19. The examples are at discrete times throughout a measurement period, in this particular example, spanning seven hours. The graphs 2000a-f each has a box 2002a-f that identifies a period of lowest call volume during the measured seven hours. This time naturally presents itself as a candidate time to select for performing network equipment functions, such as upgrades and repairs, that require the network equipment to go off-line. The call volume data can be saved as a historical data record for later use in selecting these candidate times for taking the equipment off-line.

According to one embodiment of the present invention, the historical data, along with other network parameters, is used to predict an optimum time frame to take a particular network element (i.e., BTS, CBSC, etc) off-line. In another embodiment of the present invention, real-time or quasi-real-time monitoring is utilized and compared to a dynamic threshold level for determining a suitable point in time for taking the candidate network element off-line. In yet another embodiment, historical data is combined with real-time or quasi-real-time monitoring of subscriber traffic to first predict an optimum window of expected low call volume and then actively monitor actual traffic levels to initiate an off-line state of the element.

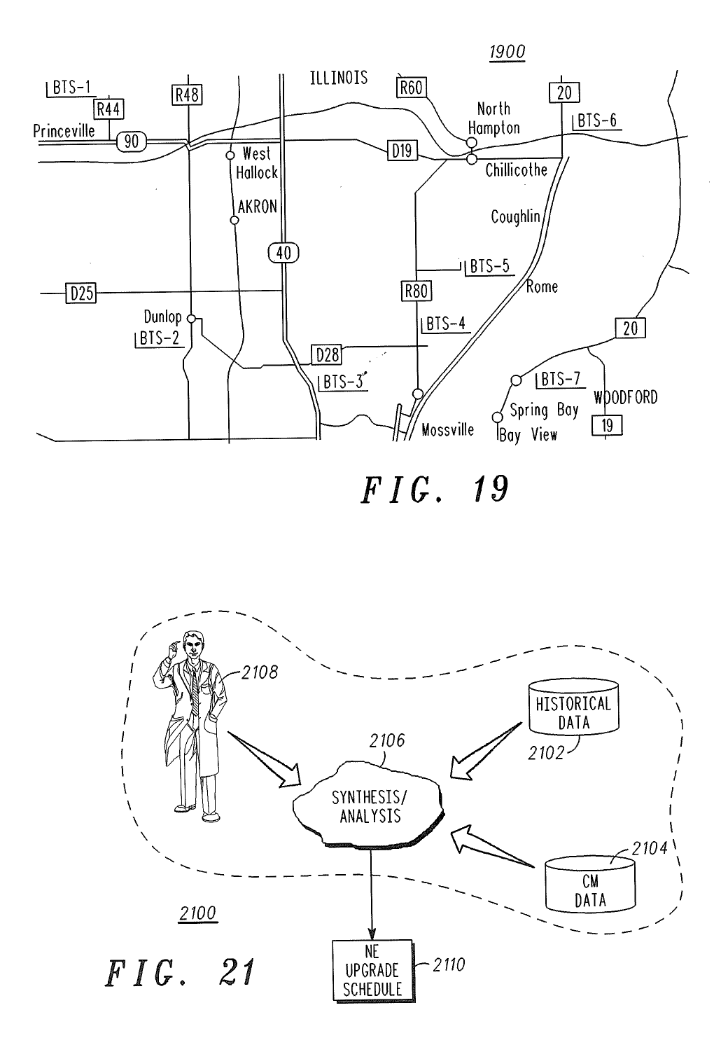

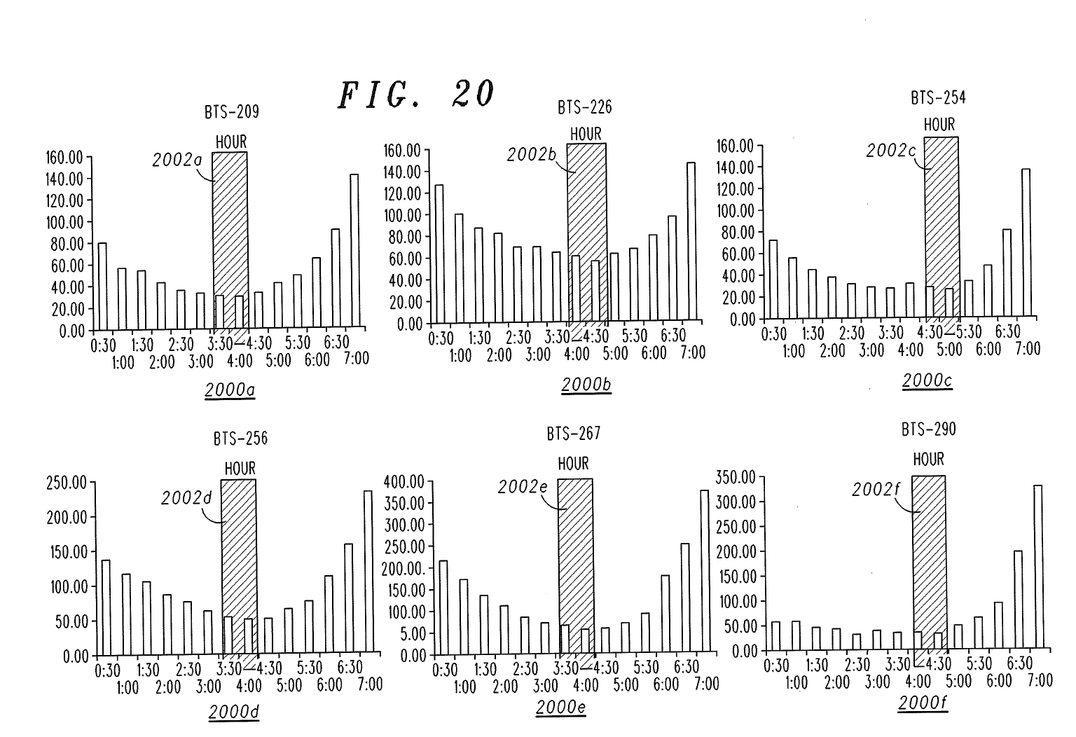

In a first embodiment of strategic scheduling 2100, shown in FIG. 21, a historical data database 2102, such as call volume history, is combined with configuration management data 2104, which can include items such as neighbor lists, parameters for configuring BTSs, locations of the BTSs, software loads, parents and children of specific BTSs, and other similar information items, and is synthesized/analyzed in a process 2106 initiated by a system operator 2108 to produce a network equipment upgrade schedule 2110.

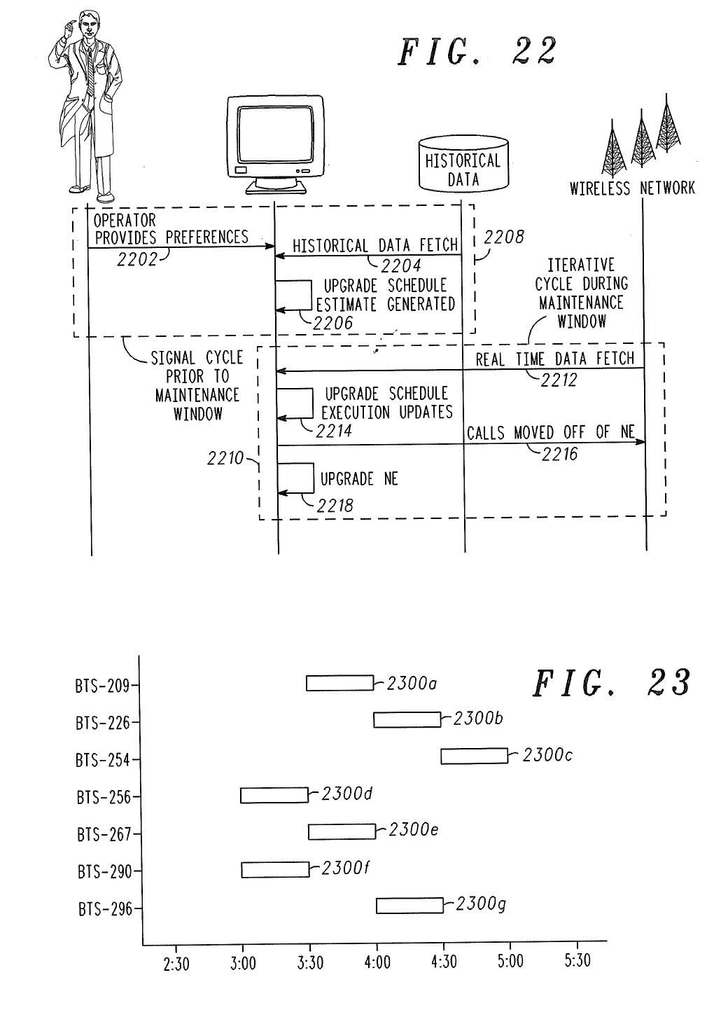

FIG. 22 is a process flow of the embodiment illustrated in FIG. 21. The flow begins at a first step 2202 with the system operator 2108 providing preferences that are to be used in determining a network equipment off-line time window. These preferences are not limited, but can include items such as a particular time frame to focus on, a certain subset of all BTSs or other network elements to focus on, or any other configuration data. In a next step 2204, historical data is retrieved from the historical data database 2102. From these two inputs, a schedule is generated in step 2206. FIG. 23 shows an example of a candidate schedule based on the measurements shown in FIG. 20. The x-axis is a range of AM time slots and each BTS, labeled on the y-axis, has a box 2300a-g indicating an optimum time window for each BTS to be taken off-line. It should be noted that a candidate schedule might not be able to be faithfully followed because, as explained in previous sections herein, factors such as neighbor lists, coverages, hand-off scenarios, and others can be factored in to minimize the number of dropped and/or blocked calls resulting from a particular piece of equipment going off-line. Steps 2202-2206 of the process flow shown in FIG. 22 are performed in what is considered a single cycle 2208 and are done prior to a determined maintenance window in which the network equipment will be taken off-line.

In the particular embodiment just described, network elements, such as BTSs and CBSCs can be taken off-line at specified times to minimize the number of blocked and/or dropped calls by strategically utilizing call volume history information and system preferences and/or parameters. Call volume history utilization provides added reliability to wireless networks and further improves subscriber satisfaction.

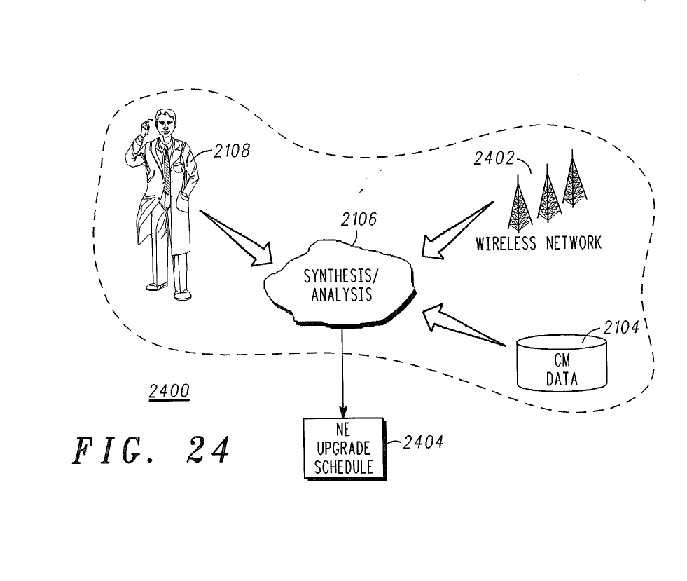

In another embodiment of the present invention, shown in FIG. 24, configuration management data 2104 is combined with real-time or quasi-real-time data received from the network 2402, and is synthesized/analyzed in a process 2106 initiated by a system operator 2108, who is able to select a set of preferences and/or conditions, to produce a network equipment upgrade schedule 2404. In this embodiment, network elements are upgraded using only current call data.

Returning to FIG. 22, an iterative cycle 2210 is shown. The cycle 2210 occurs during a maintenance window as opposed to the cycle 2208, which occurs prior to the maintenance window. The cycle 2210 starts at step 2212 by capturing a real-time data measurement of the amount of call traffic being handled by a particular network element. This measurement is compared to a threshold value and, if it meets the requirement for traffic volume, the schedule is updated in step 2214. Next, in step 2216, calls are moved off of the BTS or other subject network equipment according to the methods described above. Next, in step 2218, service is performed on the off-line element.

In one embodiment of the present invention, utilizing real-time traffic monitoring, the BTSs are sorted and measured according to threshold values. In at least one embodiment, the threshold values are dynamic and change with time. In another embodiment, BTSs selected for going off-line are placed in an order based on a real-time measurement of the number of one-leg calls connected through each candidate BTS. One-leg calls are calls that are not within coverage of, and are not able to be handed off to, neighboring BTSs. Therefore, one-leg calls are guaranteed to be dropped when a particular BTS from which it is obtaining service goes off-line. For this reason, the cell, or BTS, with the most one-leg calls, will be saved for last to go off-line, in hopes that the one-leg callers will move to a portion of the cell that is covered by multiple BTSs.

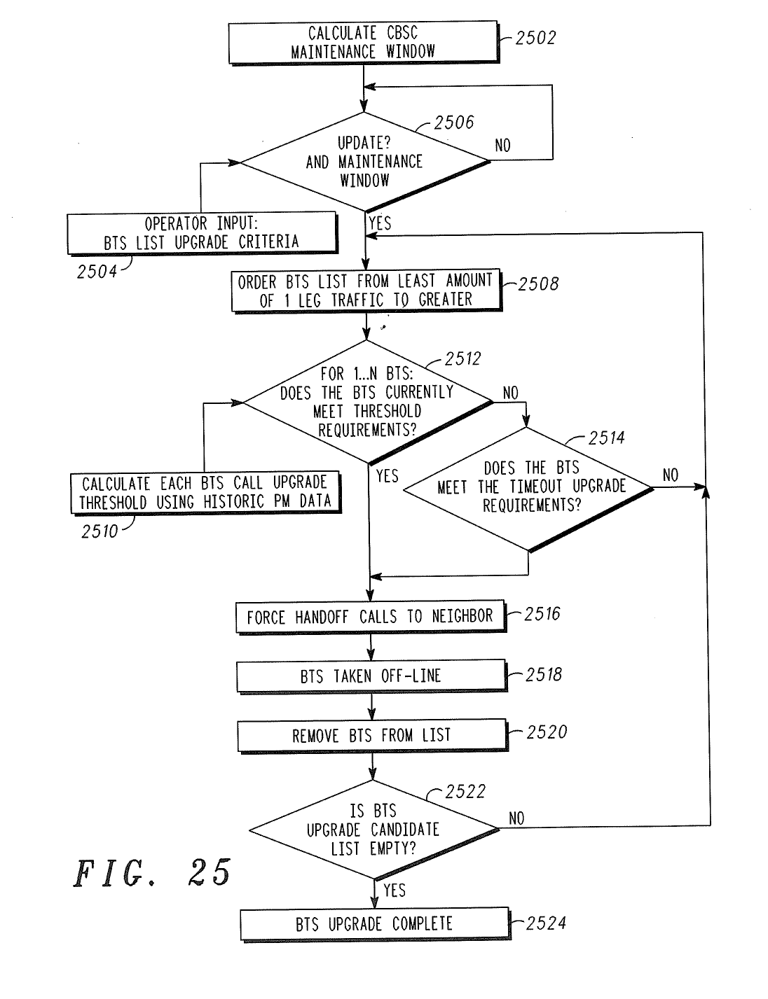

In a further embodiment of the present invention, real time traffic monitoring is combined with historic data. FIG. 25 is a process flow of one example of this embodiment. Before real-time monitoring begins, a maintenance window is selected in step 2502. The window selected can be based on any criteria. In a step 2504, BTS list upgrade criteria is input into the system by an operator or automatically input by a computer. Examples of list upgrade criteria are maintenance window start times, maintenance window end times, BTS devices to be upgraded, preferred (VIP) BTS Devices—preferential treatment in the algorithm, operator preferences for upgrade rate or minimal service impact, operator preferences for multiple maintenance windows, and others. A check is then performed in step 2506 as to whether a particular BTS meets the upgrade criteria and whether it is currently within the predefined maintenance window. If the answer to either question is no, the flow continuously loops until both of the conditions is met. Alternatively, if the answer to step 2506 is yes, the flow moves to step 2508, where candidate BTSs are ordered from least amount of one-leg traffic to greatest number of one-leg traffic.

In step 2510, a threshold is calculated for each BTS being considered for going off-line. This threshold is based, at least in part, on the historical data stored in the historical data database 2102. In certain embodiments, this threshold will dynamically change with the passing of time to compensate for expected call-traffic increases or decreases, as are shown in FIG. 20. In step 2512, a comparison is made, using the thresholds calculated in step 2510, for each of the BTSs ordered from 1 to N, based on the one-leg criteria explained above, to determine whether or not they currently meet the threshold requirement.

In certain circumstances, a maintenance window will be presented and a minimum traffic threshold will be set based on reliable historical data, but during the window the threshold is never met due to an anomaly in subscriber traffic. In this situation, the network element that needs service or upgrading would never be automatically taken off-line. Therefore, in one embodiment of the present invention, a timeout duration value is set, whereby an expired time is compared to the timeout duration and if the network element is not taken off-line due to meeting the threshold requirement, it will be automatically taken down once the expired time exceeds the timeout duration so that service can be provided. Therefore, if the result of step 2512 is no, the flow moves to step 2514, where a query is performed to determine whether or not the BTS exceeds the predefined upgrade timeout requirement. If the result of the query of step 2514 is also no, the flow moves back up to step 2508 where real-time data is again gathered to determine network traffic conditions and the BTS on the candidate list are again ordered based on the number of one-leg calls being handled.

If either query 2512 or query 2524 results in a No, the flow moves to step 2515 where, according to the previously described embodiments, calls are handed off to neighbor cells. In step 2518, the BTS is taken off-line and in step 2520, the BTS is then removed from the list of candidate BTSs.

A check is performed at step 2522 to determine whether or not any other BTSs remain on the list of candidate BTSs. If at least one BTS remains on the list, the flow moves back up to step 2508. However, if all BTS have been taken off-line and, therefore, removed from the list, the flow moves to step 2524 where the process ends.

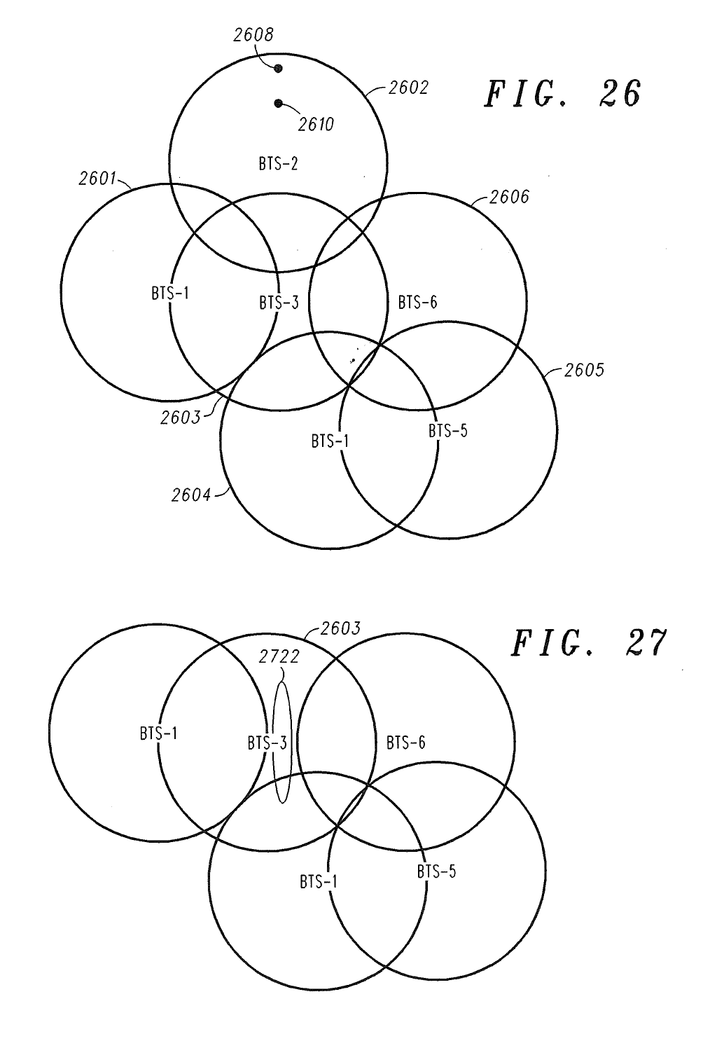

FIGS. 26-27 show one example of an embodiment of the present invention in use. FIG. 26 shows BTSs 1-6, each with a coverage area 2601-2606, respectively. Each dot represents a subscriber device receiving service from the network, i.e., local BTS. Those dots that are only surrounded by a single one of the circles 2601-2606 are one-leg calls. As described with reference to step 2508 of FIG. 25, the BTSs are placed in order with those BTSs serving an area with the least amount of one-leg calls being at the top. In the example shown in FIG. 26, BTS-2 has only two one leg callers 2608 and 2610, which is the least amount of any of the six cells shown. Therefore, BTS-2 will be the first network element candidate to be taken off-line, which will potentially only drop callers 2608 and 2610. All other callers in the coverage area 2602 of BTS-2 will, by following the handoff methods detailed in the preceding sections, be successfully handed off to neighbor BTSs.

Still looking at FIG. 26, it can be seen that BTS-3 has the next fewest one-leg callers. Therefore, as shown in FIG. 27, BTS-3 is the next network element to be taken off-line and the one-leg traffic in the center 2702 of the cell 2603 will be dropped. All of the other traffic within coverage area 2603 can be handed off to neighbor BTSs. This process repeats with each BTS in the ordered list. However, in some instances, a BTS down the list will have to wait until one or more of the off-line BTSs comes back on-line before it can go off-line itself. This is due to the number of one-leg callers increasing as cells drop off-line. For this reason, embodiments of the present invention utilize a threshold number of one-leg callers, where a BTS will not be taken off-line, regardless of its order in the list, if the number of one-leg callers served by that BTS exceeds the threshold.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for taking network elements off-line, the method comprising:
setting at least one threshold traffic value for each of at least two network elements;
monitoring, with an information processing system, in substantially real-time, a number of calls being handled by each of the at least two network elements;
determining a number of one-leg calls currently being handled by each of the at least two network elements;
comparing the number of substantially real-time monitored calls being handled by one of the at least two network elements currently handling the fewest one-leg calls to a corresponding one of the threshold values; and
taking the one of the at least two network elements currently handling the fewest one-leg calls off-line if the number of substantially real-time monitored calls being handled by the one of the at least two network elements currently handling the fewest one-leg calls is below the corresponding one of the threshold values.

2. The method according to claim 1, further comprising:
changing the threshold traffic values based on a time of day of the monitoring.

3. The method according to claim 1, further comprising:
comparing the number of substantially real-time monitored calls being handled by one of the at least two network elements currently handling the next fewest one-leg calls to a corresponding one of the threshold values; and
taking the one of the at least two network elements currently handling the next fewest one-leg calls off-line if the number of substantially real-time monitored calls being handled by the one of the at least two network elements currently handling the next fewest one-leg calls is below the corresponding one of the threshold values.

4. The method according to claim 1, further comprising:
comparing the number of one-leg calls currently being handled by the one of the at least two network elements to a one-leg call threshold value; and
causing the one of the at least two network elements to stay on-line if the number of one-leg calls currently being handled by that network element exceeds the one-leg call threshold value.

5. The method according to claim 1, further comprising:
comparing an expired time to a timeout duration value; and
taking the one of the at least two network elements currently handling the fewest one-leg calls off-line if the expired time exceeds the timeout duration value.

6. The method according to claim 1, further comprising:
moving calls being handled each of the network elements prior to taking each of the network elements off-line.

7. A method for taking network elements off-line, the method comprising:
storing a record of a number of calls being handled by a first network element over a period of time;
setting a threshold value based on the record;
monitoring, with an information processing system, in substantially real-time, a number of calls being handled by the first network element;
comparing the number of substantially real-time monitored calls being handled by the first network element to the threshold value; and
taking the first network element off-line if the number of substantially real-time monitored calls being handled by the first network element is below the threshold value.

8. The method according to claim 7, further comprising:
changing the threshold value based on a time of day of the monitoring.

9. The method according to claim 7, further comprising:
storing, prior to the taking step, a record of a number of calls being handled by a second network element;
setting, prior to the taking step, a threshold value based on the record for the second network element;
monitoring, prior to the taking step, in substantially real-time, a number of calls being handled by the second network element;
determining, prior to the taking step, a number of one-leg calls currently being handled by each of the first network element and the second network element; and
taking the second network element off-line prior to taking the first network element off-line if the number of substantially real-time monitored calls being handled by the second network element is below the threshold value and the number of one-leg calls currently being handled by the second network element is less than the number of one-leg calls currently being handled by the first network element.

10. The method according to claim 9, wherein the processor:
comparing the number of one-leg calls currently being handled by each of the first network element and second network element to a one-leg call threshold value; and
causing at least one of the network elements to stay on-line if the number of one-leg calls currently being handled by that network element exceeds the one-leg call threshold value.

11. The method according to claim 7, further comprising:
comparing an expired time to a timeout duration value; and
taking the first network element off-line if the expired time exceeds the timeout duration value.

12. The method according to claim 7, further comprising:
moving calls being handled by the first network element to a second network element prior to taking the first network element off-line.

13. A system for taking network elements off-line, the system comprising:
a memory for storing a record of a number of calls being handled by a first network element over a period of time;
a processor communicatively coupled to the memory, the processor for:
setting a threshold value based on the record;
monitoring in substantially real-time, a number of calls being handled by the first network element; and
comparing the number of substantially real-time monitored calls being handled by the first network element to the threshold value; and
a switch, communicatively coupled to the processor, for taking the first network element off-line if the number of substantially real-time monitored calls being handled by the first network element is below the threshold value.

14. The system according to claim 13, wherein:
the processor modifies the threshold value based on a time of day of the monitoring.

15. The system according to claim 13, further comprising:
a record of a number of calls being handled by a second network element in the memory, and wherein the processor:
sets, prior to the taking step, a threshold value based on the record for the second network element;
monitors, prior to the taking step, in substantially real-time, a number of calls being handled by the second network element;
determines, prior to the taking step, a number of one-leg calls currently being handled by each of the first network element and the second network element; and
causes the switch to take the second network element off-line prior to taking the first network element off-line if the number of substantially real-time monitored calls being handled by the second network element is below the threshold value and the number of one-leg calls currently being handled by the second network element is less than the number of one-leg calls currently being handled by the first network element.

16. The system according to claim 15, wherein the processor:
compares the number of one-leg calls currently being handled by each of the first network element and second network element to a one-leg call threshold value; and
causes at least one of the network elements to stay on-line if the number of one-leg calls currently being handled by that network element exceeds the one-leg call threshold value.

17. The system according to claim 13, wherein the processor:
compares an expired time to a timeout duration value; and
causes the switch to take the first network element off-line if the expired time exceeds the timeout duration value.

18. The system according to claim 13, wherein calls being handled by the first network element are moved to a second network element prior to taking the first network element off-line.
